(19) United States
(12) Patent Application Publication
(10) Pub. No.: US 2024/0231249 A1
(43) Pub. Date: Jul. 11, 2024

(54) TONER

(71) Applicant: CANON KABUSHIKI KAISHA, Tokyo (JP)

(72) Inventors: MAKI IMURA, Kanagawa (JP); KOHEI YOSHIYAMA, Chiba (JP); NOBUHIRO YOSHIDA, Ibaraki (JP); KENTA MITSUIKI, Ibaraki (JP); KENTARO KAMAE, Kanagawa (JP); YUU NISHIMURA, Chiba (JP); KAZUNARI OOYAMA, Ibaraki (JP); NOBUYOSHI SUGAHARA, Tokyo (JP); YUYA CHIMOTO, Chiba (JP); TAKAHO SHIBATA, Tokyo (JP)

(21) Appl. No.: 18/333,853

(22) Filed: Jun. 13, 2023

(30) Foreign Application Priority Data
Dec. 21, 2022 (JP) 2022-204136
Apr. 12, 2023 (JP) 2023-064683

(51) Int. Cl. G03G 9/087

(52) U.S. Cl. CPC G03G 9/08755

(57) ABSTRACT

Provided is a toner containing a binder resin, wherein the binder resin contains an amorphous polyester and a crystalline polyester, and wherein, when the toner is used as a sample in differential scanning calorimetry (DSC) involving a first process of increasing a temperature from 20° C. to 180° C., a second process of decreasing the temperature from 180° C. to 20° C., and a third process of increasing the temperature from 20° C. to 180° C., DSC curves have a specific endothermic peak or exothermic peak derived from the crystalline polyester, and when a temperature of a maximum peak top of the endothermic peak in the DSC curve obtained through the first process is represented by T1 (° C.), and a temperature of a maximum peak top of the endothermic peak in the third DSC curve is represented by T2 (° C.), the Tl and the T2 satisfy the following expression (1).

$$- 1. \leq T 2 - T 1 \qquad ( 1 )$$

### BACKGROUND OF THE INVENTION

### Field of the Invention

The present invention relates to a toner to be used in, for example, an electrophotographic system, an electrostatic recording system, and an electrostatic printing system.

### Description of the Related Art

In recent years, along with an increasingly widespread use of an electrophotographic full-color copying machine, there have been demands for improvements in additional performances, such as energy saving performance, shortening of a restoration time from a sleep state, and adaptation to various media, as well as further increases in speed and image quality.

Specifically, as a toner adapted to save energy, there is a demand for a toner excellent in low-temperature fixability, which can be fixed at lower temperatures, in order to reduce power consumption in a fixing process. In view of this, as the toner excellent in low-temperature fixability, in Japanese Patent Application Laid-Open No. 2004-046095, there is proposed a toner using a crystalline polyester for a binder resin of the toner.

In addition, from the viewpoint of shortening of the restoration time from a sleep state, there is a demand for a toner excellent in charging maintaining property, which undergoes little change in charge quantity throughout a long-term sleep state. In view of this, as the toner excellent in charging maintaining property, in Japanese Patent Application Laid-Open No. 2018-156074, there is proposed a toner using a crystalline polyester and a crystalline polyvinyl resin that has high hydrophobicity.

Further, thick coated paper serving as one of the various media contains a large amount of inorganic fine particles of calcium carbonate or the like in order to enhance whiteness, and hence a coefficient of friction due to rubbing between sheets of the paper becomes large, with the result that, in a fixed image, the toner is liable to be peeled from the paper. Accordingly, there is a demand for a toner excellent in scratch resistance, for suppressing the peeling of the toner due to the rubbing between sheets of the paper. In view of this, as the toner excellent in scratch resistance, in Japanese Patent Application Laid-Open No. 2013-200559, there is proposed a toner using a carbonic acid salt-containing filler.

### SUMMARY OF THE INVENTION

The toner described in Japanese Patent Application Laid-Open No. 2004-046095 uses a crystalline polyester. The crystalline polyester has a sharp melt characteristic as compared to an amorphous polyester, and also functions as a plasticizer for the amorphous polyester, and hence is a material effective for low-temperature fixing of a toner. However, it has been found that, when the crystalline polyester is excessively compatible with the binder resin, low electrical resistance of the crystalline polyester is liable to cause, for example, a reduction in charge quantity of the toner under high temperature and high humidity, resulting in a poor charging maintaining property in some cases.

Meanwhile, the toner described in Japanese Patent Application Laid-Open No. 2018-156074 has a sharp melt property and exhibits excellent low-temperature fixability and an excellent charging maintaining property by using a crystalline polyester and a crystalline polyvinyl resin that has high hydrophobicity. However, the crystalline polyvinyl resin has high affinity for wax, and hence exudation of the wax is suppressed to make it difficult to form a wax layer on the surface of a fixed image. It has been found that, as a result of the foregoing, the coefficient of friction due to rubbing between sheets of paper is not reduced, and hence the toner of the fixed image is peeled from the paper in some cases.

In addition, the toner described in Japanese Patent Application Laid-Open No. 2013-200559 exhibits excellent scratch resistance by using a binder resin containing a crystalline resin, and further using a filler. However, it has been found that, although an effect is obtained on crystallization, the influence of a filler effect is significant, resulting in poor low-temperature fixability in some cases.

Because of the foregoing, it has been difficult to satisfy all of the low-temperature fixability, the charging maintaining property, and the scratch resistance. In view of this, there is a pressing need to develop a toner showing an excellent charging maintaining property and excellent scratch resistance, and further showing low-temperature fixability with which the toner can be fixed at lower temperatures.

The present invention has been made in view of such problems as described above, and the present invention provides a toner showing an excellent charging maintaining property and excellent scratch resistance, and further showing low-temperature fixability with which the toner can be fixed at lower temperatures.

The present invention relates to a toner including a toner particle containing a binder resin, wherein the binder resin contains an amorphous polyester and a crystalline polyester, and wherein, when the toner is used as a sample in differential scanning calorimetry (DSC) involving:
[I] a first process of increasing a temperature from 20° C. to 180° C. at a rate of temperature increase of 10° C./min;
[II] a second process of decreasing the temperature from 180° C. to 20° C. at a rate of temperature decrease of 10° C./min subsequent to the first process; and
[III] a third process of increasing the temperature from 20° C. to 180° C. at a rate of temperature increase of 10° C./min subsequent to the second process,
(i) a first DSC curve obtained through the first process has an endothermic peak having a peak top temperature in a range of from 80° C. or more to 100° C. or less and being derived from the crystalline polyester,
(ii) a second DSC curve obtained through the second process has an exothermic peak having a peak top temperature in a range of from 40° C. or more to 80° C. or less and being derived from the crystalline polyester, and the exothermic peak in the second DSC curve has an exothermic quantity of 0.5 J/g or more,
(iii) a third DSC curve obtained through the third process has an exothermic peak having a peak top temperature in a range of from 40° C. or more to 80° C. or less and being derived from the crystalline polyester, and an endothermic peak having a peak top temperature in a region of from 80° C. or more to 100° C. or less and being derived from the crystalline polyester, and the exothermic peak in the third DSC curve has an exothermic quantity of 1.5 J/g or more, and
(iv) when a temperature of a maximum peak top of the endothermic peak in the first DSC curve is represented by T1 (° C.), and a temperature of a maximum peak top of the endothermic peak in the third DSC curve is represented by T2 (° C.), the T1 and the T2 satisfy the following expression (1).

$$- 1. \leq T 2 - T 1 \qquad ( 1 )$$

Further features of the present invention will become apparent from the following description of exemplary embodiments.

### DESCRIPTION OF THE EMBODIMENTS

In the present invention, the description “oo or more and xx or less” or “from oo to xx” representing a numerical range means a numerical range including a lower limit and an upper limit that are end points unless otherwise stated.

In addition, the term “monomer unit” refers to a form in which a monomer substance has reacted in a polymer.

Further, the term “crystalline resin” refers to a resin having an endothermic peak observed in differential scanning calorimetry (DSC).

The present invention relates to a toner including a toner particle containing a binder resin, wherein the binder resin contains an amorphous polyester and a crystalline polyester, and wherein, when the toner is used as a sample in differential scanning calorimetry (DSC) involving:
[I] a first process of increasing a temperature from 20° C. to 180° C. at a rate of temperature increase of 10° C./min;
[II] a second process of decreasing the temperature from 180° C. to 20° C. at a rate of temperature decrease of 10° C./min subsequent to the first process; and
[III] a third process of increasing the temperature from 20° C. to 180° C. at a rate of temperature increase of 10° C./min subsequent to the second process,
(i) a first DSC curve obtained through the first process has an endothermic peak having a peak top temperature in a range of from 80° C. or more to 100° C. or less and being derived from the crystalline polyester,
(ii) a second DSC curve obtained through the second process has an exothermic peak having a peak top temperature in a range of from 40° C. or more to 80° C. or less and being derived from the crystalline polyester, and the exothermic peak in the second DSC curve has an exothermic quantity of 0.5 J/g or more,
(iii) a third DSC curve obtained through the third process has an exothermic peak having a peak top temperature in a range of from 40° C. or more to 80° C. or less and being derived from the crystalline polyester, and an endothermic peak having a peak top temperature in a region of from 80° C. or more to 100° C. or less and being derived from the crystalline polyester, and the exothermic peak in the third DSC curve has an exothermic quantity of 1.5 J/g or more, and
(iv) when a temperature of a maximum peak top of the endothermic peak in the first DSC curve is represented by T1 (° C.), and a temperature of a maximum peak top of the endothermic peak in the third DSC curve is represented by T2 (° C.), the T1 and the T2 satisfy the following expression (1).

−1.0≤T2−T1 (1)

The inventors have made investigations on a toner showing an excellent charging maintaining property and excellent scratch resistance, and further showing low-temperature fixability with which the toner can be fixed at lower temperatures. As described in Japanese Patent Application Laid-Open No. 2004-046095, the crystalline polyester, when compatibilized with the amorphous polyester, functions as a plasticizer for the amorphous polyester, and hence excellent low-temperature fixability is obtained. Meanwhile, the molecular mobility of a matrix is increased, and hence the charging maintaining property is poor, with the result that it is difficult to achieve both of the low-temperature fixability and the charging maintaining property. In addition, the crystalline polyester is not crystallized, and hence the effect of a low coefficient of friction is not obtained, with the result that the scratch resistance also becomes poor. Meanwhile, when the crystalline polyester is crystallized in the amorphous polyester, the molecular mobility of the matrix is lowered, and hence an excellent charging maintaining property is obtained. However, the crystalline polyester does not function as a plasticizer for the amorphous polyester, and hence the low-temperature fixability becomes poor, with the result that it is difficult to achieve both of the low-temperature fixability and the charging maintaining property.

The inventors have made further investigations, and have found that the above-mentioned trade-off relationship can be escaped by controlling the generation of a quasi-crystallized state of the crystalline polyester and its growth from the quasi-crystallized state to a crystallized state. Herein, the “quasi-crystallized state” and “crystallized state” of the crystalline polyester refer to degrees of alignment of the folded structure of molecules, and the two states have different melting points.

In order to obtain an excellent charging maintaining property, it is important to lower the molecular mobility of the matrix, and the crystalline polyester does not need to be in the crystallized state, but only needs to be in the quasi-crystallized state. Further, when the crystalline polyester is in the quasi-crystallized state, its melting point is low, and hence its diffusion into the amorphous polyester at the time of fixation also occurs easily. Accordingly, excellent low-temperature fixability is obtained. Meanwhile, in order to obtain excellent scratch resistance, it is important that the effect of low friction be expressed, and it is required that the crystalline polyester be in the crystallized state. For this reason, it is important that even heat remaining on paper after a fixing process allow crystal growth to occur from the quasi-crystallized state to the crystallized state.

The inventors have made investigations as to a configuration that enables the generation of the quasi-crystallized state of the crystalline polyester and its growth from the quasi-crystallized state to the crystallized state after fixation described above, and as a result, have found that the configuration can be achieved through material design to be described later.

Further, the inventors have found the following indicators regarding the generation of the quasi-crystallized state of the crystalline polyester and its growth from the quasi-crystallized state to the crystallized state.

Specifically, the inventors have found that, when the toner is used as a sample in differential scanning calorimetry (DSC) involving:
[I] the first process of increasing the temperature from 20° C. to 180° C. at a rate of temperature increase of 10° C./min;
[II] the second process of decreasing the temperature from 180° C. to 20° C. at a rate of temperature decrease of 10° C./min subsequent to the first process; and
[III] the third process of increasing the temperature from 20° C. to 180° C. at a rate of temperature increase of 10° C./min subsequent to the second process, the exothermic peak obtained in the second process has a correlation with the generation of the quasi-crystallized state of the crystalline polyester, and the exothermic peak obtained in the third process has a correlation with the growth of the crystalline polyester from the quasi-crystallized state to the crystallized state. In addition, it is conceived to be evidence of the occurrence of crystal growth to the crystallized state that the peak top temperature of the endothermic peak obtained in the third process is similar to the peak top temperature of the endothermic peak obtained in the first process.

In order to achieve the above-mentioned configuration, it is conceivably important that the crystalline polyester and the amorphous polyester be in such a combination that affinity therebetween is high, and that the crystalline polyester have such a configuration as to have a high intermolecular force to facilitate crystal growth. A specific configuration of the crystalline polyester for achieving the foregoing is described later.

### (Features of Each Configuration)

The toner of the present invention includes a toner particle containing a binder resin, and the binder resin contains an amorphous polyester and a crystalline polyester.

The toner of the present invention has an endothermic peak A derived from the crystalline polyester in the first DSC curve obtained through the above-mentioned first process. In addition, the endothermic peak A has a peak top temperature at 80° C. or more and 100° C. or less.

Further, the toner of the present invention has an exothermic peak B derived from the crystalline polyester in the second DSC curve obtained through the above-mentioned second process. Further, the exothermic peak B has a peak top temperature at 40° C. or more and 80° C. or less. In addition, the exothermic quantity of the exothermic peak B is 0.5 J/g or more.

When the peak top temperature of the exothermic peak B falls within the above-mentioned range, it is indicated that the quasi-crystallized state of the crystalline polyester is generated in the cooling process. Accordingly, the molecular motion of the matrix is suppressed to make it difficult for charge paths to be formed, and hence an excellent charging maintaining property is obtained.

In addition, the exothermic quantity of the exothermic peak B is 0.5 J/g or more, preferably 0.5 J/g or more and less than 3.5 J/g, more preferably 0.5 J/g or more and less than 2.0 J/g. When the exothermic quantity of the exothermic peak B falls within the above-mentioned ranges, it is conceived that the crystalline polyester is quasi-crystallized instead of being crystallized in the cooling process. In this case, the molecular motion of the matrix is suppressed to make it difficult for charge paths to be formed, and hence an excellent charging maintaining property is obtained. In addition, when the crystalline polyester is in the quasi-crystallized state, its melting point is low, and hence its diffusion into the amorphous polyester at the time of fixation also occurs easily. Accordingly, excellent low-temperature fixability is obtained.

The toner of the present invention has an exothermic peak C derived from the crystalline polyester in the third DSC curve obtained through the third process. Further, the exothermic peak C has a peak top temperature at 40° C. or more and 80° C. or less, and has an exothermic quantity of 1.5 J/g or more. In addition, in the third DSC curve, an endothermic peak D derived from the crystalline polyester is also present. Further, the endothermic peak D has a peak top temperature at 80° C. or more and 100° C. or less.

When the peak top temperature of the exothermic peak C falls within the above-mentioned range, it is meant that the crystalline polyester has undergone crystal growth from the quasi-crystallized state generated in the second process to the crystallized state. That is, it is indicated that, after fixation, heat remaining on paper allows the crystalline polyester to transition from the quasi-crystallized state to the crystallized state. Accordingly, the crystalline polyester having the crystallized state is present in a fixed image, resulting in an image having a lower coefficient of friction and having excellent scratch resistance.

The exothermic quantity of the exothermic peak C is 1.5 J/g or more, preferably 1.5 J/g or more and less than 7.5 J/g, more preferably 1.5 J/g or more and less than 5.5 J/g. When the exothermic quantity of the exothermic peak C falls within the above-mentioned ranges, it is indicated that the growth of the crystalline polyester from the quasi-crystallized state to the crystallized state has sufficiently occurred. Accordingly, the crystalline polyester having the crystallized state is present in the fixed image, resulting in an image having a lower coefficient of friction and having excellent scratch resistance.

In addition, in the toner of the present invention, when the temperature of the maximum peak top of the endothermic peak A is represented by T1 (° C.), and the temperature of the maximum peak top of the endothermic peak D is represented by T2 (° C.), the T1 and the T2 satisfy the following expression (1).

$$- 1. \leq T 2 - T 1 \qquad ( 1 )$$

When the expression (1) is satisfied, it is conceived that the quasi-crystal of the crystalline polyester generated in the cooling process has sufficiently grown to be crystalline. Accordingly, the crystalline polyester having the crystallized state is present in a fixed image, resulting in an image having a lower coefficient of friction and having excellent scratch resistance.

T2−T1 more preferably satisfies the following expression (4), and still more preferably satisfies the following expression (5).

$$- 1. \leq T 2 - T 1 \leq 2. \qquad ( 4 )$$

$$- 1. \leq T 2 - T 1 \leq 1. \qquad ( 5 )$$

The toner of the present invention is preferably as follows from the viewpoint of excellent scratch resistance: the third DSC curve obtained through the third process has an endothermic peak derived from the crystalline polyester at 70° C. or more and 100° C. or less, and the endothermic quantity of the endothermic peak is 3.0 J/g or more.

When the endothermic peak derived from the crystalline polyester in the third DSC curve falls within the above-mentioned range, it is indicated that there exists a crystal amount sufficient for the crystalline polyester to grow to be purely crystalline, to thereby express a low coefficient of friction. Accordingly, a stable crystal can be borne on an image surface to provide an image having a lower coefficient of friction, and hence excellent scratch resistance can be obtained. The endothermic peak derived from the crystalline polyester in third DSC curve is preferably 3.0 J/g or more and less than 10.0 J/g, more preferably 3.0 J/g or more and less than 8.0 J/g.

It is preferred from the viewpoint of the scratch resistance that the crystalline polyester have, as units forming a main chain (polyester backbone) thereof, a structure derived from a linear aliphatic polyhydric alcohol c1 having 2 or more and 6 or less carbon atoms and a structure derived from a linear aliphatic polyvalent carboxylic acid c2, and a difference in carbon number between the linear aliphatic polyhydric alcohol c1 and the linear aliphatic polyvalent carboxylic acid c2 be 6 or more.

When the crystalline polyester has the above-mentioned structure, the density of ester bond moieties in the crystalline polyester is high, enhancing its intermolecular force, and hence the folding of molecular chains is promoted therefrom. As a result, the crystallization speed of the crystalline polyester is increased, and hence the temperature of the maximum peak top of the endothermic peak A in the first DSC curve and the temperature of the maximum peak top of the endothermic peak D in the third DSC curve easily satisfy the above-mentioned expression (1). As a result, excellent scratch resistance is obtained. The carbon number of the linear aliphatic polyhydric alcohol c1 is preferably 2 or more and 4 or less, more preferably 2 or 3. The difference in carbon number between the linear aliphatic polyhydric alcohol c1 and the linear aliphatic polyvalent carboxylic acid c2 is preferably 8 or more and 16 or less, more preferably 9 or more and 14 or less. When the difference in carbon number between the linear aliphatic polyhydric alcohol c1 and the linear aliphatic polyvalent carboxylic acid c2 is 14 or less, the low-temperature fixability is likely to become more satisfactory. The difference in carbon number between the linear aliphatic polyhydric alcohol c1 and the linear aliphatic polyvalent carboxylic acid c2 may be controlled based on, for example, the kinds of the monomers.

The crystalline polyester preferably contains a modified crystalline polyester having a structure in which a hydroxy group at a main chain terminal is terminally modified with an aliphatic monocarboxylic acid having 16 or more and 31 or less (preferably 16 or more and 26 or less, more preferably 16 or more and 24 or less) carbon atoms, or a modified crystalline polyester having a structure in which a carboxy group at a main chain terminal is terminally modified with an aliphatic monoalcohol having 15 or more and 30 or less (preferably 15 or more and 26 or less, more preferably 15 or more and 22 or less) carbon atoms. In addition, the ratio of the terminally modified structure among the main chain terminals of all molecules in the crystalline polyester is preferably 80.0% or more from the viewpoints of the scratch resistance and the charging maintaining property.

The structure in which the hydroxy group at the main chain terminal is terminally modified with the aliphatic monocarboxylic acid is represented by the following formula (A). In addition, the structure in which the carboxy group at the main chain terminal is terminally modified with the aliphatic monoalcohol having 15 or more and 30 or less carbon atoms is represented by the following formula (B). In the formulae, P represents the main chain structure of the crystalline polyester. In the formula (A), —COR¹ represents a partial structure formed through the terminal modification with the aliphatic monocarboxylic acid, and in the formula (B), —OR² represents a partial structure formed through the terminal modification with the aliphatic monoalcohol.

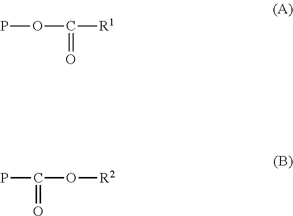

When the crystalline polyester is terminally modified as described above, there can be provided a starting point for the folded structure of the main chain of the crystalline polyester like a crystal nucleating agent. Further, the polarity of the crystalline polyester itself can be lowered, and its compatibility with the amorphous polyester can be suppressed, and hence its crystallinity can be enhanced. Accordingly, the crystalline polyester can be partially crystallized in the cooling process after the temperature increase in the first process to achieve a state in which the amorphous polyester and the crystalline polyester are partially compatible with each other, and hence an excellent charging maintaining property and excellent low-temperature fixability are obtained.

In addition, when the content ratio of the terminally modified structure in the crystalline polyester falls within the above-mentioned range, an effect of enhancing its crystallinity and an effect of lowering the polarity of the crystalline polyester to suppress its compatibility with the amorphous polyester are exhibited. Accordingly, the crystalline polyester can be partially crystallized in the cooling process after the temperature increase in the first process to achieve a state in which the amorphous polyester and the crystalline polyester are partially compatible with each other, and hence an excellent charging maintaining property and excellent low-temperature fixability are obtained. The content ratio of the terminally modified structure in the crystalline polyester is preferably 90.0% or more and 100.0% or less, more preferably 95.0% or more and 100.0% or less. The terminally modified structure of the crystalline polyester and the content ratio thereof may be controlled based on, for example, the kind and addition amount of the monomer of the terminally modifying aliphatic monocarboxylic acid or aliphatic monoalcohol.

When the melting point of the crystalline polyester is represented by T_{C}, T_{C} preferably satisfies the following expression (2) from the viewpoints of the scratch resistance and the charging maintaining property.

$$85. \leq Tc \leq 93. \qquad ( 2 )$$

When the melting point T_{C} of the crystalline polyester falls within the above-mentioned range, its intermolecular force is enhanced, and hence the folding is promoted therefrom. Accordingly, the crystallization speed of the crystalline polyester is increased, and the crystalline polyester can be further phase-separated, and hence the scratch resistance and the charging maintaining property are obtained. T_{C}(° C. is more preferably 86.0° C. or more and 92.0° C. or less, still more preferably 87.0° C. or more and 92.0° C. or less. The melting point T_{C} of the crystalline polyester may be controlled based on, for example, the content of the crystalline polyester, the kinds of monomers thereof, and the molecular weight thereof.

When the SP value [unit: (J/cm³)^{0.5}] of the crystalline polyester is represented by SP_{C}, and the SP value of the amorphous polyester is represented by SP_{A}, SP_{A} and SP_{C} preferably satisfy the following expression (3) from the viewpoints of the low-temperature fixability and the scratch resistance.

$$2. \leq {SP}_{A} - {SP}_{C} \leq 4.5 \qquad ( 3 )$$

When SP_{A} and SP_{C} fall within the above-mentioned range, the amorphous polyester and the crystalline polyester have a certain affinity for each other, and hence the crystalline polyester expressing a low coefficient of friction is easily borne on the amorphous polyester, with the result that a more excellent effect on the scratch resistance is obtained. In addition, at the time of fixation, the molten crystalline polyester is compatible with the amorphous polyester, and hence a more excellent effect on the low-temperature fixability is obtained. SP_{A}−SP_{C} more preferably satisfies the following expression (6), and still more preferably satisfies the following expression (7). SP_{A} and SP_{C} may be controlled based on the kinds and addition amounts of the monomers.

$$2.7 \leq {SP}_{A} - {SP}_{C} \leq 4.1 \qquad ( 6 )$$

$$3.1 \leq {SP}_{A} - {SP}_{C} \leq 3.7 \qquad ( 7 )$$

In the toner, the softening point of the amorphous polyester measured with a flow tester is represented by T_{A} (° C.). The softening point of a molten mixture of the amorphous polyester and the crystalline polyester mixed at a mass ratio between the amorphous polyester and the crystalline polyester in the toner is represented by T_{M} (° C.). A difference (T_{A}−T_{M}) between T_{A} and T_{M} is preferably 7° C. or more and 17° C. or less from the viewpoint of the low-temperature fixability.

When the difference between T_{A} and T_{M} falls within the above-mentioned range, it is indicated that, at the time of fixation, the molten crystalline polyester is compatible with the amorphous polyester, and hence a more excellent effect on the low-temperature fixability is obtained. The difference between T_{A} and T_{M} is preferably 8° C. or more and 17° C. or less, more preferably 10° C. or more and 17° C. or less. The difference between T_{A} and T_{M} may be controlled based on the kinds of the monomers of the amorphous polyester and the crystalline polyester and the addition amounts thereof.

The binder resin preferably contains 5 mass % or more and 15 mass % or less of the crystalline polyester from the viewpoints of the low-temperature fixability and the charging maintaining property.

When the content of the crystalline polyester in the binder resin falls within the above-mentioned range, the amorphous polyester is plasticized, and hence excellent low-temperature fixability is obtained. The content of the crystalline polyester in the binder resin is preferably 8 mass % or more and 15 mass % or less, more preferably 10 mass % or more and 15 mass % or less. The content of the crystalline polyester in the binder resin may be controlled based on the addition amount of the crystalline polyester.

Configurations of the toner that are preferred in the present invention are described in detail below.

### [Amorphous Polyester]

A polyhydric alcohol (dihydric or trihydric or higher alcohol) and a polyvalent carboxylic acid (divalent or trivalent or higher carboxylic acid), or an acid anhydride or lower alkyl ester thereof are used as monomers to be used for the polyester unit of the amorphous polyester to be used in the toner of the present invention.

The following polyhydric alcohol monomers may each be used as a polyhydric alcohol monomer to be used for the polyester unit of the amorphous polyester.

As a dihydric alcohol component, there are given, for example: ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, hydrogenated bisphenol A, and a bisphenol represented by the formula (C) and derivatives thereof:

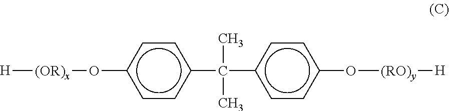

where R represents an ethylene or propylene group, “x” and “y” each represent an integer of 0 or more, and the average of x+y is 0 or more and 10 or less; and a diol represented by the formula (D):

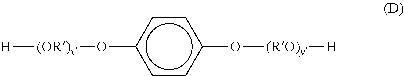

where R′ represents

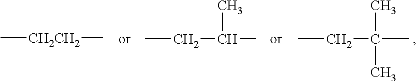

and x′ and y′ each represent an integer of 0 or more, and the average of x′+y′ is 0 or more and 10 or less.

As a trihydric or higher alcohol component, there are given, for example, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene. Of those, glycerol, trimethylolpropane, and pentaerythritol are preferably used. Those dihydric alcohols and trihydric or higher alcohols may be used alone or in combination thereof.

The following polyvalent carboxylic acid monomers may each be used as a polyvalent carboxylic acid monomer to be used for the polyester unit of the polyester.

As a divalent carboxylic acid component, there are given, for example, maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, n-octylsuccinic acid, isooctenylsuccinic acid, and isooctylsuccinic acid, and anhydrides of those acids and lower alkyl esters thereof. Of those, maleic acid, fumaric acid, terephthalic acid, and n-dodecenylsuccinic acid are preferably used.

Examples of the trivalent or higher carboxylic acid, the acid anhydride thereof, or the lower alkyl ester thereof include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, EMPOL trimer acid, and acid anhydrides thereof or lower alkyl esters thereof. Of those, 1,2,4-benzenetricarboxylic acid, i.e., trimellitic acid or a derivative thereof is particularly preferably used because trimellitic acid or the derivative thereof is available at low cost and its reaction can be easily controlled. Those divalent carboxylic acids and trivalent or higher carboxylic acids may be used alone or in combination thereof.

In addition, in the present invention, a block copolymer having an amorphous polyester segment a1, an amorphous polyester segment a2, and a crosslinking moiety is preferably used as the amorphous polyester.

Such a configuration that a difference (SPₐ₂−SPₐ₁) between the SP value (SPₐ₁) of the amorphous polyester segment a1 and the SP value (SPₐ₂) of the amorphous polyester segment a2 is 2.0 (J/cm³)^{0.5} or more is preferred, and the configuration may be appropriately selected in accordance with purposes.

The polyhydric alcohol (dihydric or trihydric or higher alcohol), and polyvalent carboxylic acid (divalent or trivalent or higher carboxylic acid), acid anhydride thereof, or lower alkyl ester thereof described above are used as the constituent monomers of the amorphous polyester segment a1. In addition, the amorphous polyester segment a1 preferably contains monomer units derived from terephthalic acid, fumaric acid, and trimellitic acid out of those monomers.

The polyhydric alcohol (dihydric or trihydric or higher alcohol), and polyvalent carboxylic acid (divalent or trivalent or higher carboxylic acid), acid anhydride thereof, or lower alkyl ester thereof described above are used as the constituent monomers of the amorphous polyester segment a2.

A method of polymerizing the amorphous polyester segment a1 and the amorphous polyester segment a2 to produce a block copolymer may be appropriately selected in accordance with purposes without any particular limitation. Examples thereof include methods described in the following (1) to (3). Of those, from the viewpoint of the degree of freedom in molecular design, (1) or (3) is preferred, and (1) is more preferred.

(1) A method involving dissolving or dispersing an amorphous polyester a1 prepared through a polymerization reaction in advance and an amorphous polyester a2 prepared through a polymerization reaction in advance in an appropriate solvent, and subjecting the mixture to a reaction with a chain extender having two or more functional groups each of which reacts with a hydroxy group at a polymer chain terminal, such as carboxylic acids, isocyanate groups, epoxy groups, or carbodiimide groups, to thereby perform copolymerization.

(2) A method involving loading the amorphous polyester a1 prepared through a polymerization reaction in advance and the amorphous polyester a2 prepared through a polymerization reaction in advance into a twin-screw extruder together with a transesterification catalyst or the like, and preparing the block copolymer by a reactive extrusion method using the twin-screw extruder and the like.

(3) A method involving using a hydroxy group of the amorphous polyester a1 prepared through a polymerization reaction in advance as a polymerization-initiating component to subject the amorphous polyester a2 to ring-opening polymerization from a polymer chain terminal of the amorphous polyester a1, to thereby perform copolymerization.

The crosslinking moiety is not particularly limited, and may be exemplified by a copolymer of a styrene-based component and an acrylic acid-based and/or methacrylic acid-based component.

Examples of monomers to be used for forming the crosslinking moiety include the following.

Examples of the monomers to be used in the crosslinking moiety include: styrene derivatives, such as o-methylstyrene, m-methylstyrene, p-methylstyrene, p-methoxystyrene, and p-phenylstyrene; α-methylene aliphatic monocarboxylic acid esters, such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate; and acrylic acid esters, such as methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate, and phenyl acrylate. Of those, methyl methacrylate, ethyl methacrylate, and methyl acrylate are preferably used.

A method of producing the block copolymer having the crosslinking moiety is not particularly limited, but examples thereof include the following methods.
(i) A production method involving performing a transesterification reaction between a polymer containing a monomer component having an ester group, such as an acrylic acid ester or a methacrylic acid ester, and a polyester component.
(ii) A production method involving performing an esterification reaction between a polymer containing a monomer component having a carboxylic acid group, such as acrylic acid or methacrylic acid, and a polyester component.
(iii) A production method involving polymerizing the constituent monomer components of a styrene-acrylic copolymer moiety in the presence of a polyester moiety containing a monomer component having an unsaturated bond, such as fumaric acid.

The method of producing the block copolymer having the amorphous polyester segment a1, the amorphous polyester segment a2, and the crosslinking moiety is suitably a production method involving, as described above, incorporating a monomer capable of reacting with both the styrene-acrylic copolymer moiety and the polyester moiety into the constituent monomer components of the styrene-acrylic copolymer moiety and/or into the constituent monomer component of the polyester moiety, and performing a reaction therebetween.

### [Crystalline Polyester]

A polyhydric alcohol (dihydric or trihydric or higher alcohol), and a polyvalent carboxylic acid (divalent or trivalent or higher carboxylic acid), an acid anhydride thereof, or a lower alkyl ester thereof are used as the constituent monomers of the crystalline polyester to be used in the toner of the present invention.

A polyhydric alcohol monomer is not particularly limited, but is preferably a chain (more preferably straight-chain) aliphatic diol. Examples thereof include ethylene glycol, diethylene glycol, triethylene glycol, 1,2-propylene glycol, 1,3-propylene glycol, dipropylene glycol, 1,4-butanediol, 1,4-butadiene glycol, trimethylene glycol, tetramethylene glycol, pentamethylene glycol, hexamethylene glycol, octamethylene glycol, nonamethylene glycol, decamethylene glycol, and neopentyl glycol. Of those, straight-chain aliphatic diols, such as ethylene glycol, diethylene glycol, 1,4-butanediol, and 1,6-hexanediol, and α,ω-diols are particularly preferred examples.

Other examples of the polyhydric alcohol monomer include: an aromatic alcohol, such as polyoxyethylenated bisphenol A or polyoxypropylenated bisphenol A; and 1,4-cyclohexanedimethanol. In addition, examples of a trihydric or higher polyhydric alcohol monomer out of the polyhydric alcohol monomers include: an aromatic alcohol such as 1,3,5-trihydroxymethylbenzene; and an aliphatic alcohol, such as pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, or trimethylolpropane.

A polyvalent carboxylic acid monomer is not particularly limited, but is preferably a chain (more preferably straight-chain) aliphatic dicarboxylic acid. Specific examples thereof include: oxalic acid, malonic acid, succinic acid, glutaric acid, adipic acid, pimelic acid, suberic acid, glutaconic acid, azelaic acid, sebacic acid, nonanedicarboxylic acid, decanedicarboxylic acid, undecanedicarboxylic acid, dodecanedicarboxylic acid, maleic acid, fumaric acid, mesaconic acid, citraconic acid, and itaconic acid; and products obtained by hydrolyzing acid anhydrides or lower alkyl esters thereof.

Other examples of the polyvalent carboxylic acid monomer include: an aromatic carboxylic acid, such as isophthalic acid or terephthalic acid; an aliphatic carboxylic acid, such as n-dodecylsuccinic acid or n-dodecenylsuccinic acid; an alicyclic carboxylic acid such as cyclohexanedicarboxylic acid; and acid anhydrides or lower alkyl esters thereof. In addition, examples of a trivalent or higher polyvalent carboxylic acid out of the other carboxylic acid monomers include: an aromatic carboxylic acid, such as 1,2,4-benzenetricarboxylic acid (trimellitic acid), 2,5,7-naphthalenetricarboxylic acid, 1,2,4-naphthalenetricarboxylic acid, or pyromellitic acid; an aliphatic carboxylic acid, such as 1,2,4-butanetricarboxylic acid, 1,2,5-hexanetricarboxylic acid, or 1,3-dicarboxy-2-methyl-2-methylenecarboxypropane; and derivatives, such as acid anhydrides or lower alkyl esters, thereof.

The crystalline polyester is preferably a modified crystalline polyester having a structure in which a hydroxy group at a main chain terminal is terminally modified with an aliphatic monocarboxylic acid having 15 or more and 30 or less carbon atoms, or a polymer having a structure in which a carboxy group at a main chain terminal is terminally modified with an aliphatic monoalcohol having 15 or more and 30 or less carbon atoms.

Examples of the aliphatic monocarboxylic acid having 15 or more and 30 or less carbon atoms include palmitic acid (hexadecanoic acid), margaric acid (heptadecanoic acid), stearic acid (octadecanoic acid), nonadecylic acid, arachidic acid (icosanoic acid), henicosanoic acid, behenic acid (docosanoic acid), tetracosanoic acid, hexacosanoic acid, octacosanoic acid, and triacontanoic acid.

Examples of the aliphatic monoalcohol having 15 or more and 30 or less carbon atoms include palmityl alcohol (hexadecanol), margaryl alcohol (heptadecanol), stearyl alcohol (octadecanol), nonadecanol, arachidyl alcohol (icosanol), heneicosanol, behenyl alcohol, lignoceryl alcohol, ceryl alcohol, 1-heptacosanol, montanyl alcohol, 1-nonacosanol, and myricyl alcohol.

The crystalline polyester in the present invention may be produced in accordance with an ordinary polyester synthesis method. For example, the crystalline polyester may be obtained by: subjecting the carboxylic acid monomer and alcohol monomer described above to an esterification reaction or a transesterification reaction; and then subjecting the resultant to a polycondensation reaction in accordance with an ordinary method under reduced pressure or while introducing a nitrogen gas. After that, the desired crystalline polyester may be obtained by further adding the above-mentioned aliphatic compound and performing an esterification reaction.

The esterification or transesterification reaction may be performed using a general esterification catalyst or transesterification catalyst, such as sulfuric acid, titanium butoxide, dibutyltin oxide, manganese acetate, or magnesium acetate, as required. In addition, the polycondensation reaction may be performed using a known catalyst, for example, an ordinary polymerization catalyst, such as titanium butoxide, dibutyltin oxide, tin acetate, zinc acetate, tin disulfide, antimony trioxide, or germanium dioxide. A polymerization temperature and a catalyst amount are not particularly limited, and may be appropriately determined.

In the esterification or transesterification reaction, or the polycondensation reaction, for example, any of the following methods may be used: all the monomers are collectively loaded for improving the strength of the crystalline polyester to be obtained; and the divalent monomers are caused to react with each other first, and then a monomer that is trivalent or more is added to, and caused to react with, the resultant, for reducing the amount of a low-molecular weight component.

### [Wax]

The toner particle of the toner of the present invention may contain a wax. Examples of the wax include the following.

Hydrocarbon-based waxes, such as low-molecular-weight polyethylene, low-molecular-weight polypropylene, an alkylene copolymer, microcrystalline wax, paraffin wax, and Fischer-Tropsch wax; oxidized products of hydrocarbon-based waxes such as oxidized polyethylene wax, or block copolymers thereof; waxes each containing a fatty acid ester as a main component such as carnauba wax; and waxes obtained by partially or wholly deacidifying fatty acid esters such as deacidified carnauba wax.

Of those, from the viewpoints of the low-temperature fixability and hot offset resistance of the toner, a hydrocarbon-based wax, such as paraffin wax or Fischer-Tropsch wax, or a fatty acid ester-based wax such as carnauba wax is preferred.

In the present invention, from the viewpoint of the fixing separability of the toner, a hydrocarbon-based wax is more preferred.

The content of the wax in the toner particle is preferably 1.0 part by mass or more and 20.0 parts by mass or less with respect to 100 parts by mass of the binder resin in the toner particle. When the content of the wax falls within the above-mentioned range, hot offset resistance at high temperature is further improved.

In addition, from the viewpoint of achieving both of the storage stability and hot offset resistance of the toner, the following is preferably satisfied regarding the peak temperature of the maximum endothermic peak of the toner.

That is, in an endothermic curve at the time of temperature increase measured with a differential scanning calorimeter (DSC), the peak temperature of the maximum endothermic peak present in the temperature range of from 30° C. or more to 200° C. or less is preferably 50° C. or more and 110° C. or less.

### [Dispersant]

When a release agent is incorporated into the toner particle of the toner of the present invention, a dispersant is preferably incorporated thereinto to disperse the wax in the resin. As the dispersant, a known one may be utilized, but when a hydrocarbon-based wax is incorporated as the wax, a polymer having a structure obtained through a reaction between a vinyl-based resin component and a hydrocarbon compound is preferably incorporated to disperse the wax in the resin. Of those, a graft polymer obtained by graft-polymerizing a vinyl-based monomer onto a polyolefin is preferably incorporated.

When such polymer is incorporated, compatibility between the wax and the resin is promoted, and hence a detrimental effect, such as charging failure or member contamination, due to wax dispersion failure is hardly caused. In addition, the content of the dispersant is preferably 1.0 part by mass or more and 15 parts by mass or less with respect to 100 parts by mass of the binder resin. When the content falls within this range, the dispersion state of the wax in the amorphous resin easily becomes uniform.

The polyolefin is not particularly limited as long as the polyolefin is a polymer or copolymer of an unsaturated hydrocarbon, and various polyolefins may be used. In particular, a polyethylene-based or polypropylene-based polyolefin is preferably used. A plurality of those polyolefins may be used.

Examples of a monomer having a vinyl-based group include the following.

Styrene-based units, such as styrene and derivatives thereof, for example, styrene, o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, and p-n-dodecylstyrene.

Vinyl-based units each having a N atom, for example: amino group-containing α-methylene aliphatic monocarboxylic acid esters, such as dimethylaminoethyl methacrylate and diethylaminoethyl methacrylate; and acrylic acid or methacrylic acid derivatives, such as acrylonitrile, methacrylonitrile, and acrylamide.

Vinyl-based units each having a carboxy group, for example: unsaturated dibasic acids, such as maleic acid, citraconic acid, itaconic acid, an alkenylsuccinic acid, fumaric acid, and mesaconic acid; unsaturated dibasic acid anhydrides, such as maleic anhydride, citraconic anhydride, itaconic anhydride, and an alkenylsuccinic anhydride; half esters of unsaturated dibasic acids, such as a methyl maleate half ester, an ethyl maleate half ester, a butyl maleate half ester, a methyl citraconate half ester, an ethyl citraconate half ester, a butyl citraconate half ester, a methyl itaconate half ester, a methyl alkenylsuccinate half ester, a methyl fumarate half ester, and a methyl mesaconate half ester; unsaturated dibasic acid esters, such as dimethyl maleate and dimethyl fumarate; α,β-unsaturated acids, such as acrylic acid, methacrylic acid, crotonic acid, and cinnamic acid; α,β-unsaturated acid anhydrides, such as crotonic anhydride and cinnamic anhydride, and anhydrides of the α,β-unsaturated acids and lower fatty acids; and an alkenylmalonic acid, an alkenylglutaric acid, and an alkenyladipic acid, acid anhydrides thereof, and monoesters thereof.

Vinyl-based units each having a hydroxy group, for example, acrylic acid or methacrylic acid esters, such as 2-hydroxyethyl acrylate, 2-hydroxyethyl methacrylate, and 2-hydroxypropyl methacrylate, and polymerizable monomers each having a hydroxy group, 4-(1-hydroxy-1-methylbutyl)styrene, and 4-(1-hydroxy-1-methylhexyl)styrene.

Ester units formed of acrylic acid esters, for example, acrylic acid esters, such as methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate, and phenyl acrylate.

Ester units formed of methacrylic acid esters, for example, α-methylene aliphatic monocarboxylic acid esters, such as cyclohexyl methacrylate, methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate. A plurality of those units may be used.

The dispersant to be used in the present invention may be obtained by a known method, such as a reaction between those polymers described above, or a reaction between the monomer of one polymer and another polymer.

### [Colorant]

The toner particle of the toner of the present invention may contain a colorant as required. Examples of the colorant include the following.

As a black colorant, there are given, for example: carbon black; and a colorant toned to a black color with a yellow colorant, a magenta colorant, and a cyan colorant. As the colorant, a pigment may be used alone, or a dye and a pigment may be used in combination. From the viewpoint of the image quality of a full-color image, a dye and a pigment are preferably used in combination.

As a pigment for magenta toner, there are given, for example: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, or 282; C.I. Pigment Violet 19; and C.I. Vat Red 1, 2, 10, 13, 15, 23, 29, or 35. As a dye for magenta toner, there are given, for example: oil-soluble dyes, such as: C.I. Solvent Red 1, 3, 8, 23, 24, 25, 27, 30, 49, 81, 82, 83, 84, 100, 109, or 121; C.I. Disperse Red 9; C.I. Solvent Violet 8, 13, 14, 21, or 27; and C.I. Disperse Violet 1; and basic dyes, such as: C.I. Basic Red 1, 2, 9, 12, 13, 14, 15, 17, 18, 22, 23, 24, 27, 29, 32, 34, 35, 36, 37, 38, 39, or 40; and C.I. Basic Violet 1, 3, 7, 10, 14, 15, 21, 25, 26, 27, or 28.

As a pigment for cyan toner, there are given, for example: C.I. Pigment Blue 2, 3, 15:2, 15:3, 15:4, 16, or 17; C.I. Vat Blue 6; C.I. Acid Blue 45; and a copper phthalocyanine pigment in which a phthalocyanine skeleton is substituted by 1 to 5 phthalimidomethyl groups.

For example, C.I. Solvent Blue 70 is given as a dye for cyan toner.

As a pigment for yellow toner, there are given, for example: C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, or 185; and C.I. Vat Yellow 1, 3, or 20.

For example, C.I. Solvent Yellow 162 is given as a dye for yellow toner.

Those colorants may be used alone or as a mixture thereof, or may be used in a solid solution state. The colorant is selected from the viewpoints of a hue angle, chroma, lightness, light fastness, OHP transparency, and dispersibility in the toner. The content of the colorant is preferably 0.1 part by mass or more and 30.0 parts by mass or less with respect to 100 parts by mass of the binder resin.

### [Charge Control Agent]

The toner particle of the toner of the present invention may contain a charge control agent as required. The blending of the charge control agent enables the stabilization of charge characteristics and the control of the optimal triboelectrification quantity in accordance with a developing system.

Although a known charge control agent may be utilized as the charge control agent, a metal compound of an aromatic carboxylic acid is particularly preferred because the compound is colorless, increases the charging speed of the toner, and can stably hold a constant charge quantity.

As a negative charge control agent, there are given, for example: a salicylic acid metal compound; a naphthoic acid metal compound; a dicarboxylic acid metal compound; a polymer-type compound having a sulfonic acid or a carboxylic acid in a side chain thereof; a polymer-type compound having a sulfonate or a sulfonic acid esterified product in a side chain thereof; a polymer-type compound having a carboxylate or a carboxylic acid esterified product in a side chain thereof; a boron compound; a urea compound; a silicon compound; and a calixarene.

The charge control agent may be internally added to the toner particle, or may be externally added thereto. The content of the charge control agent is preferably 0.2 part by mass or more and 10.0 parts by mass or less, more preferably 0.5 part by mass or more and 10.0 parts by mass or less with respect to 100 parts by mass of the binder resin.

### [Inorganic Fine Particles]

The toner particle of the toner of the present invention may contain inorganic fine particles as required.

Examples of the inorganic fine particles include such fine particles as silica fine particles, titanium oxide fine particles, alumina fine particles, or complex oxide fine particles thereof. Of the inorganic fine particles, silica fine particles and titanium oxide fine particles are preferred because of fluidity improvement and charging uniformity.

The inorganic fine particles are preferably hydrophobized with a hydrophobizing agent, such as a silane compound, a silicone oil, or a mixture thereof.

From the viewpoint of improving fluidity, the inorganic fine particles serving as an external additive preferably have a specific surface area of 50 m²/g or more and 400 m²/g or less. In addition, from the viewpoint of improving durable stability, the inorganic fine particles serving as an external additive preferably have a specific surface area of 10 m²/g or more and 50 m²/g or less. In order to achieve both of the fluidity improvement and the durable stability, inorganic fine particles having specific surface areas in the above-mentioned ranges may be used in combination.

The content of the external additive is preferably 0.1 part by mass or more and 10.0 parts by mass or less with respect to 100 parts by mass of the toner particle. A known mixer such as a Henschel mixer may be used in the mixing of the toner particle and the external additive.

### [Developer]

The toner of the present invention may be used as a one-component developer, but is preferably used as a two-component developer by being mixed with a magnetic carrier in order to further improve its dot reproducibility, and to supply a stable image over a long time period.

When the toner is used as a two-component developer by being mixed with a magnetic carrier, the mixing ratio of the magnetic carrier at that time is preferably 2 mass % or more and 15 mass % or less, more preferably 4 mass % or more and 13 mass % or less in terms of toner concentration in the two-component developer.

### [Magnetic Carrier]

A generally known magnetic carrier, such as: iron oxide; particles of a metal, such as iron, lithium, calcium, magnesium, nickel, copper, zinc, cobalt, manganese, chromium, strontium, or a rare earth, particles of alloys thereof, and particles of oxides thereof; a magnetic material, such as ferrite or magnetite; a magnetic material-dispersed resin carrier (so-called resin carrier) containing a magnetic material and a binder resin holding the magnetic material under a state in which the magnetic material is dispersed therein; and a magnetic carrier having a form in which ferrite or magnetite particles each having a pore are filled with a resin, may be used as the magnetic carrier.

As the magnetic carrier, any of the above-mentioned magnetic materials may be directly used, or a magnetic material obtained by using any of the above-mentioned magnetic materials as a core and coating the surface thereof with a resin may be used. From the viewpoint of improving the chargeability of the toner, a magnetic material obtained by using any of the above-mentioned magnetic materials as a core and coating the surface thereof with a resin is suitably used as the magnetic carrier.

The resin for coating the core is not particularly limited, and a known one may be selected and used to the extent that the above-mentioned toner characteristics are not impaired, and there may be used, for example, a resin, such as a (meth)acrylic resin, a silicone resin, a urethane resin, polyethylene, polyethylene terephthalate, polystyrene, or a phenol resin, or a copolymerized polymer or polymer mixture containing any such resins. In particular, a (meth)acrylic resin or a silicone resin is preferably used from the viewpoints of charging characteristics, the prevention of adhesion of foreign matter to the surface of the carrier, and the like. In particular, a (meth)acrylic resin having an alicyclic hydrocarbon group, such as a cyclohexyl group, a cycloheptyl group, a cyclooctyl group, a cyclopentyl group, a cyclobutyl group, or a cyclopropyl group, is a particularly preferred form because the surface (coating film surface) of a resin coating layer with which the surface of the magnetic material is coated becomes smooth, and hence the adhesion of a toner-derived component, such as the binder resin, the release agent, or the external additive, can be suppressed.

### [Method of Producing Toner Particle]

The toner particle of the present invention may be produced by a known method of producing a toner particle, such as a melt-kneading method, an emulsion aggregation method, or a dissolution suspension method.

A toner production procedure based on a pulverization method is described below.

In a raw material-mixing step, predetermined amounts of, for example, the binder resin, the release agent, the colorant, the crystalline polyester, a water-soluble polyvalent metal salt, and as required, any other component such as the charge control agent, serving as constituent materials for the toner particle are weighed, and the materials are blended and mixed. An example of a mixing apparatus is a double cone mixer, a V-type mixer, a drum-type mixer, a super mixer, a Henschel mixer, a Nauta mixer, or MECHANO HYBRID (manufactured by Nippon Coke & Engineering Co., Ltd.).

Next, the mixed materials are melt-kneaded to disperse the wax and the like in the binder resin. In the melt-kneading step, a batch-type kneader, such as a pressure kneader or a Banbury mixer, or a continuous kneader may be used, and a single-screw or twin-screw extruder has been in the mainstream because of the following superiority: the extruder can perform continuous production. Examples thereof include a KTK-type twin-screw extruder (manufactured by Kobe Steel, Ltd.), a TEM-type twin-screw extruder (manufactured by Toshiba Machine Co., Ltd.), a PCM kneader (manufactured by Ikegai Ironworks Corp.), a twin-screw extruder (manufactured by K.C.K.), a co-kneader (manufactured by Buss), and KNEADEX (manufactured by Nippon Coke & Engineering Co., Ltd.). Further, a resin composition obtained by the melt-kneading may be rolled with a twin-roll mill or the like, and may be cooled with water or the like in a cooling step.

Next, the cooled product of the resin composition is pulverized into a desired particle diameter in a pulverizing step. In the pulverizing step, the cooled product is coarsely pulverized with a pulverizer, such as a crusher, a hammer mill, or a feather mill, and is then further finely pulverized with, for example, KRYPTRON SYSTEM (manufactured by Kawasaki Heavy Industries, Ltd.), SUPER ROTOR (manufactured by Nisshin Engineering Inc.), TURBO MILL (manufactured by Turbo Kogyo Co., Ltd.), or a fine pulverizer based on an air jet system.

After that, as required, the finely pulverized product is classified with a classifier or a sifter, such as: ELBOW-JET (manufactured by Nittetsu Mining Co., Ltd.) based on an inertial classification system, or TURBOPLEX (manufactured by Hosokawa Micron Corporation), TSP SEPARATOR (manufactured by Hosokawa Micron Corporation), or FACULTY (manufactured by Hosokawa Micron Corporation) based on a centrifugal force classification system, to provide a toner particle.

Further, the surface of the toner particle is subjected to external addition treatment with an external additive as required. As a method for the external addition treatment with the external additive, there is given a method involving blending predetermined amounts of the classified toner and various known external additives, and stirring and mixing the blend through use of a mixing apparatus, such as a double cone mixer, a V-type mixer, a drum-type mixer, a super mixer, a Henschel mixer, a Nauta mixer, MECHANO HYBRID (manufactured by Nippon Coke & Engineering Co., Ltd.), or NOBILTA (manufactured by Hosokawa Micron Corporation), as an external addition machine.

### [Methods of Measuring Various Physical Properties]

Methods of measuring various physical properties are described below.

<Method of Separating Each Material from Toner>

Each of the materials in the toner may be separated through utilization of differences between the solubilities of the materials in the toner in solvents.

First separation: The toner is dissolved in methyl ethyl ketone (MEK) at 23° C. to be separated into soluble matter (the amorphous polyester) and insoluble matter (the crystalline polyester, the wax, the colorant, the inorganic fine particles, and the like).

Second separation: The insoluble matter (the crystalline polyester, the wax, the colorant, the inorganic fine particles, and the like) obtained by the first separation is dissolved in MEK at 100° C. to be separated into soluble matter (the crystalline polyester and the wax) and insoluble matter (the colorant, the inorganic fine particles, and the like).

Third separation: The soluble matter (the crystalline polyester C and the wax) obtained by the second separation is dissolved in chloroform at 23° C. to be separated into soluble matter (the crystalline polyester) and insoluble matter (the wax).

### <Method of Measuring Endothermic Peak and Endothermic Quantity, and Exothermic Peak and Exothermic Quantity of Crystalline Polyester>

In each process described below, the endothermic peak and endothermic quantity, and exothermic peak and exothermic quantity of the toner, the resin, and the like are measured using a differential scanning calorimeter “Q2000” (manufactured by TA Instruments) in conformity with ASTM D3418-82:
(i) the first process of increasing the temperature from 20° C. to 180° C. at a rate of temperature increase of 10° C./min;
(ii) the second process of decreasing the temperature from 180° C. to 20° C. at a rate of temperature decrease of 10° C./min subsequent to the first process; and
(iii) the third process of increasing the temperature from 20° C. to 180° C. at a rate of temperature increase of 10° C./min subsequent to the second process.

The melting points of indium and zinc are used for the temperature correction of the detecting portion of the apparatus, and the heat of fusion of indium is used for the correction of a heat quantity. Specifically, 3 mg of a sample is precisely weighed, loaded into a pan made of aluminum, and subjected to differential scanning calorimetry. An empty pan made of silver is used as a reference.

The peak temperature of the maximum endothermic peak in a first temperature increase process (first process) is adopted as the melting point.

When a plurality of peaks are present, the “maximum endothermic peak” refers to the peak at which the endothermic quantity becomes maximum. Further, the endothermic quantity of the maximum endothermic peak is determined. The endothermic quantity (J/g) is determined from an area surrounded by a straight line obtained by extending a baseline on a low-temperature side to a high-temperature side and a melting endothermic peak in the DSC curve.

The attribution of each peak may be determined by subjecting each single material separated from the toner described above to DSC measurement.

In addition, when the toner contains a wax in addition to the crystalline polyester, the melting peak temperatures of the crystalline polyester and the wax are close to each other, and hence their melting peaks overlap to make peak separation difficult in some cases.

In those cases, first, ΔH1, which is the sum of the melting heat quantities of the crystalline polyester and the wax, is determined from the total area of the overlapping melting peaks of the crystalline polyester and the wax in the resultant endothermic quantity curve. Then, ΔH2, which is the melting heat quantity of the wax separated from the toner described above, is determined. Then, a difference between ΔH1 and ΔH2 is determined, and a melting heat quantity ΔH derived from the crystalline polyester in the toner is determined.

<Method of Measuring Content Ratio of Monomer Unit Derived from Each Kind of Polymerizable Monomer in Crystalline Polyester>

The content ratio of the monomer unit derived from each kind of polymerizable monomer in the crystalline polyester measurement is performed by 1H-NMR under the following conditions.

Measuring apparatus: FT NMR apparatus JNM-EX400 (manufactured by JEOL Ltd.)
Measurement frequency: 400 MHZ
Pulse condition: 5.0 μs
Frequency range: 10,500 Hz
Number of scans: 64 times
Measurement temperature: 30° C.
Sample: 50 mg of a measurement sample is loaded into a sample tube having an inner diameter of 5 mm, and deuterated chloroform (CDCl₃) is added as a solvent to the tube. The sample is dissolved in the solvent in a thermostat at 40° C. to prepare a solution.

The integrated values S1, S2, S3, . . . Sn of peaks attributed to the constituents of the monomer unit derived from each kind of polymerizable monomer are calculated from the resultant ¹H-NMR chart.

The content ratio of the monomer unit derived from each kind of polymerizable monomer is determined by using the integrated values S1, S2, S3, and Sn as described below. n1, n2, n3, . . . nn each represent the number of hydrogen atoms in the constituent to which the peak to which attention has been paid for the corresponding moiety is assigned.

$$Content ratio of monomer unit derived from each kind o f polymerizable monomer ( mol \% ) = \{ ( Sn / nn ) / ( ( S 1 / n 1 ) + ( S 2 / n 2 ) + ( S 3 / n 3 ) … + ( Sn / nn ) ) \} \times 100$$

The amount of the monomer unit derived from each kind of polymerizable monomer is calculated by changing the numerator term in the same operation. When such a polymerizable monomer that the monomer unit derived from each kind of polymerizable monomer is free of any hydrogen atom is used, the measurement is performed by using ¹³C-NMR through use of ¹³C as a measurement atomic nucleus in a single-pulse mode, and the calculation is performed in the same manner as in ¹H-NMR.

### <Method of Calculating SP Value>

The SP values of the amorphous polyester segment a1 and the amorphous polyester segment a2, and the crystalline polyester are determined as described below in accordance with a calculation method proposed by Fedors.

The evaporation energy (Δei) (cal/mol) and molar volume (Δvi) (cm³/mol) of an atom or an atomic group in the molecular structure are determined from a table shown in “Polym. Eng. Sci., 14(2), 147-154 (1974).” An SP value (J/cm³)^{0.5} is determined as 2.0455×(ΣΔEi/ΣΔvi)^{0.5}.

### <Measurement of Weight-Average Molecular Weight of Crystalline Polyester by GPC>

The weight-average molecular weight (Mw) of the o-dichlorobenzene-soluble matter of the crystalline polyester at 100° C. is measured by gel permeation chromatography (GPC) as described below. First, the crystalline polyester is dissolved in o-dichlorobenzene at 100° C. over 1 hour. Then, the resultant solution is filtered with a solvent-resistant membrane filter “Myshoridisk” (manufactured by Tosoh Corporation) having a pore diameter of 0.2 μm to provide a sample solution. The concentration of an o-dichlorobenzene-soluble component in the sample solution is adjusted to about 0.1 mass %. Measurement is performed with the sample solution under the following conditions.
Apparatus: HLC-8121GPC/HT (manufactured by Tosoh Corporation)
Column: TSKgel GMHHR-H HT (7.8 cm I.D×30 cm), double (manufactured by Tosoh Corporation)
Detector: RI for high temperature
Temperature: 135° C.
Solvent: o-dichlorobenzene
Flow rate: 1.0 mL/min
Sample: 0.4 mL of a 0.1% sample is injected.

In the calculation of the molecular weight of the sample, a molecular weight calibration curve prepared with monodisperse polystyrene standard samples is used. Further, the calculation is performed through polyethylene conversion with a conversion formula derived from the Mark-Houwink viscosity equation.

<Method of measuring Acid Value of Crystalline Polyester>

The “acid value” is the number of milligrams of potassium hydroxide required for neutralizing an acid contained in 1 g of a sample. The acid value of the crystalline polyester C is measured in conformity with JIS K 0070-1992, and is specifically measured in accordance with the following procedure.

### (1) Preparation of Reagents

1.0 g of phenolphthalein is dissolved in 90 mL of ethyl alcohol (95 vol %), and ion-exchanged water is added to 100 mL to provide a phenolphthalein solution. 7 g of special-grade potassium hydroxide is dissolved in 5 mL of water, and ethyl alcohol (95 vol %) is added to a total volume of 1 L. The resultant is placed in an alkali-resistant container so as to prevent exposure to a carbon dioxide gas or the like, and is left to stand still therein for 3 days, followed by filtration to provide a potassium hydroxide solution. The resultant potassium hydroxide solution is stored in an alkali-resistant container. The factor of the potassium hydroxide solution is determined from the amount of the potassium hydroxide solution required for neutralization when 25 mL of 0.1 mol/L hydrochloric acid is taken in an Erlenmeyer flask and a few drops of the phenolphthalein solution are added, followed by titration with the potassium hydroxide solution. The 0.1 mol/L hydrochloric acid to be used is produced in conformity with JIS K 8001-1998.

### (2) Operations

### (A) Main Test

2.0 g of a pulverized sample of the crystalline polyester C is precisely weighed in a 200 mL Erlenmeyer flask, and is dissolved over 5 hours by adding 100 mL of a mixed solution of toluene/ethanol (2:1). Then, a few drops of the phenolphthalein solution are added as an indicator, and titration is performed with the potassium hydroxide solution. The endpoint of the titration is defined as the point where a pale pink color of the indicator persists for 30 seconds.

### (B) Blank Test

Titration is performed in the same manner as in the above-mentioned operation except that no sample is used (that is, only the mixed solution of toluene/ethanol (2:1) is used).

(3) The acid value is calculated by substituting the obtained results into the following equation:

$$A = [ ( C - B ) \times f \times 5.61 ] / S$$

where A represents the acid value (mgKOH/g), B represents the addition amount (mL) of the potassium hydroxide solution in the blank test, C represents the addition amount (mL) of the potassium hydroxide solution in the main test, “f” represents the factor of the potassium hydroxide solution, and S represents the mass (g) of the sample.

### <Method of Measuring Hydroxyl Value of Crystalline Polyester>

The “hydroxyl value” refers to the number of milligrams of potassium hydroxide required for neutralizing acetic acid bonded to a hydroxy group when 1 g of a sample is acetylated. The hydroxyl value of the crystalline polyester is measured in conformity with JIS K 0070-1992, and specifically, is measured in accordance with the following procedure.

### (1) Preparation of Reagent

25 g of special-grade acetic anhydride is placed in a 100 mL measuring flask, and pyridine is added to a total volume of 100 ml, followed by sufficient shaking to provide an acetylating reagent. The resultant acetylating reagent is stored in a brown bottle so as to prevent exposure to moisture, carbon dioxide, or the like.

1.0 g of phenolphthalein is dissolved in 90 mL of ethyl alcohol (95 vol %), and ion-exchanged water is added to 100 mL to provide a phenolphthalein solution.

35 g of special-grade potassium hydroxide is dissolved in 20 ml of water, and ethyl alcohol (95 vol %) is added to a total volume of 1 L. The resultant is placed in an alkali-resistant container so as to prevent exposure to a carbon dioxide gas or the like, and is left to stand therein for 3 days, followed by filtration to provide a potassium hydroxide solution. The resultant potassium hydroxide solution is stored in an alkali-resistant container. The factor of the potassium hydroxide solution is determined from the amount of the potassium hydroxide solution required for neutralization when 25 mL of 0.5 mol/L hydrochloric acid is taken in an Erlenmeyer flask and a few drops of the phenolphthalein solution are added, followed by titration with the potassium hydroxide solution. The 0.5 mol/L hydrochloric acid to be used is produced in conformity with JIS K 8001-1998.

### (2) Operations

### (A) Main Test

1.0 g of a pulverized sample of the crystalline polyester C is precisely weighed in a 200 mL round-bottom flask, and 5.0 mL of the above-mentioned acetylating reagent is precisely added thereto using a volumetric pipette. At this time, when the sample is difficult to dissolve in the acetylating reagent, a small amount of special-grade toluene is added to dissolve the sample.

A small funnel is mounted on the mouth of the flask, and the flask is heated by immersing about 1 cm of the bottom portion thereof in a glycerin bath at about 97° C. At this time, in order to prevent the temperature of the neck of the flask from rising owing to the heat of the bath, it is preferred that thick paper having a round hole made therein be mounted at the base of the neck of the flask.

After 1 hour, the flask is taken out of the glycerin bath and left standing to cool. After the standing to cool, 1 mL of water is added through the funnel, followed by shaking to hydrolyze acetic anhydride. Further, in order to achieve complete hydrolysis, the flask is heated again in a glycerin bath for 10 minutes. After standing to cool, the walls of the funnel and the flask are washed with 5 mL of ethyl alcohol.

A few drops of the phenolphthalein solution are added as an indicator, and titration is performed with the potassium hydroxide solution. The endpoint of the titration is defined as the point where a pale pink color of the indicator persists for about 30 seconds.

### (B) Blank Test

Titration is performed in the same manner as in the above-mentioned operation except that the sample of the crystalline polyester is not used.

(3) The Hydroxyl Value is Calculated by Substituting the Obtained Results into the Following Equation:

$$A = [ \{ ( B - C ) \times 28.05 \times f \} / S ] + D$$

where A represents the hydroxyl value (mgKOH/g), B represents the addition amount (ml) of the potassium hydroxide solution in the blank test, C represents the addition amount (mL) of the potassium hydroxide solution in the main test, “f” represents the factor of the potassium hydroxide solution, S represents the mass (g) of the sample, and D represents the acid value (mgKOH/g) of the crystalline polyester.

### <Method of Calculating Ratio of Terminally Modified Structure Among Main Chain Terminals in Crystalline Polyester>

The ratio of the terminally modified structure in the crystalline polyester is calculated by using the acid value, hydroxyl value, and molecular weight determined in the foregoing. Specifically, the number of moles of a terminal functional group in 1 g of the crystalline polyester is calculated using the following equation.

$$Number o f moles of terminal functional group = ( acid value + hydroxyl value ) / ( 1 , 000 \times 56.105 )$$

Next, the number of moles of 1 g of the crystalline polyester is calculated from the molecular weight of the crystalline polyester.

Number of moles of 1 g of crystalline polyester=1/Mw

The amount of the terminal functional group is calculated from the ratio of each monomer unit of the crystalline polyester calculated through the NMR described above. Specifically, in the case of an ester product of a dicarboxylic acid and a dialcohol, the functional group amount is set to 2. When trivalent or higher monomers are used, it is appropriate that the terminal functional group amount be calculated based on their molar ratio.

$$Ratio o f terminally modified structure in crystalline polyester C ( mol \% ) = [ 1 - number o f moles of t erminal functional group / ( number of moles of 1 g of c rystalline polyester \times functional group amount ) ] \times 100$$

<Measurement of Softening Points T_{A} and T_{M}>

The softening points T_{A} and T_{M} are measured through use of a constant-pressure extrusion system capillary rheometer “flow characteristic-evaluating apparatus Flow Tester CFT-500D” (manufactured by Shimadzu Corporation) in accordance with the manual attached to the apparatus. In this apparatus, a measurement sample filled in a cylinder is increased in temperature to be melted while a predetermined load is applied to the measurement sample with a piston from above, and the melted measurement sample is extruded from a die in a bottom part of the cylinder. At this time, a flow curve representing a relationship between a piston descent amount (mm) and the temperature (° C.) can be obtained.

A “melting temperature in a 1/2 method” described in the manual attached to the “flow characteristic-evaluating apparatus Flow Tester CFT-500D” is adopted as a softening point. The melting temperature in the 1/2 method is calculated as described below. First, 1/2 of a difference between a descent amount (Smax) of the piston at a time when the outflow is finished and a descent amount (Smin) of the piston at a time when the outflow is started is determined (The 1/2 of the difference is represented by X. X=(Smax-Smin)/2). Then, the temperature when the descent amount of the piston reaches the sum of X and Smin in the flow curve is the melting temperature in the 1/2 method.

The sample to be used is obtained by subjecting 1.2 g of the sample to compression molding at 10 MPa for 60 seconds through use of a tablet compressing machine (e.g., standard manual Newton press NT-100H, manufactured by NPa SYSTEM Co., Ltd.) under an environment at 25° C. to form the sample into a cylindrical shape having a diameter of 8 mm.

Specific operations in the measurement are performed in accordance with the manual attached to the apparatus.

The measurement conditions of the CFT-500D are as described below.
Test mode: heating method
Starting temperature: 60° C.
Reached temperature: 200° C.
Measurement interval: 1.0° C.
Rate of temperature increase: 4.0° C./min
Piston sectional area: 1.000 cm₂
Test load (piston load): 5.0 kgf
Preheating time: 300 seconds
Diameter of hole of die: 1.0 mm
Length of die: 1.0 mm

### (Measurement of T_{M})

The mass ratio between the amorphous polyester and the crystalline polyester in the toner is calculated based on the mass of each material obtained by the separation of each material described above. The amorphous polyester and the crystalline polyester that have been separated from the toner by the above-mentioned procedure are mixed at the calculated mass ratio, and the softening point T_{M} is obtained by using the resultant mixture as a sample.

### <Measurement of Melting Peak Temperature (Melting Point) T_{C} (° C.) of Crystalline Polyester or the Like>

The melting point (T_{C}) of the crystalline polyester or the melting point of the wax or the like is measured using a differential scanning calorimeter “Q2000” (manufactured by T_{A} Instruments) in conformity with ASTM D3418-82.

The melting points of indium and zinc are used for the temperature correction of the detecting portion of the apparatus, and the heat of fusion of indium is used for the correction of a heat quantity. Specifically, 3 mg of a sample is precisely weighed and loaded into a pan made of aluminum, and measurement is performed by using an empty pan made of aluminum as a reference under the following conditions.
Rate of temperature increase: 10° C./min
Measurement start temperature: 30° C.
Measurement end temperature: 180° C.

The measurement is performed in the measurement range of from 30° C. to 180° C. at a rate of temperature increase of 10° C./min. The temperature is increased to 180° C. once and held thereat for 10 minutes, and then the temperature is decreased to 30° C., followed by temperature increase again. The temperature corresponding to the maximum endothermic peak of the temperature-endothermic quantity curve in the range of from 30° C. to 100° C. in the second temperature increase process is adopted as the melting point.

The present invention can provide the toner showing excellent scratch resistance and an excellent charging maintaining property, and further showing low-temperature fixability with which the toner can be fixed at lower temperatures.

### EXAMPLES

The present invention is more specifically described below by way of Examples. However, the present invention is by no means limited by Examples. In the following formulations, the term “part(s)” means “part(s) by mass” unless otherwise specified.

### Production Example of Amorphous Polyester Segment a1-1

| | |
|---|---|
| Propylene oxide adduct of bisphenol A | 45.5 parts by mass (34.1 mol %) |
| (average number of moles added: 2.2 | |
| mol) | |
| Ethylene oxide adduct of bisphenol A | 27.7 parts by mass (22.7 mol %) |
| (average number of moles added: 2.2 | |
| mol) | |
| Terephthalic acid | 26.5 parts by mass (42.6 mol %) |
| Fumaric acid | 0.2 part by mass (0.5 mol %) |

The above-mentioned materials were weighed in a reaction vessel with a stirring device that had been sufficiently dried by heating. With respect to 100 parts by mass of the mixture, 0.5 part by mass of tin 2-ethylhexanoate (esterification catalyst) was added. While a nitrogen gas was introduced into the vessel to keep an inert atmosphere, the temperature was increased to 260° C. to polymerize a resin (amorphous polyester segment a1-1). The resultant amorphous polyester segment a1-1 had a weight-average molecular weight Mw of 1,635 and an SP value of 22.1 (J/cm³)^{0.5.}

### Production Examples of Amorphous Polyester Segments a1-2 to a1-9

Amorphous polyester segments a1-2 to a1-9 were each obtained by performing a reaction in the same manner as in the production example of the amorphous polyester segment a1-1 except that the respective polymerizable monomers and the numbers of parts thereof were changed as shown in Table 1, and the reaction time was changed so as to achieve a molecular weight shown in Table 1.

TABLE 1

| Amorphous | | | | | | | | | | | | | | | | SP | Weight- |
|---|---|---|---|---|---|---|---|---|---|---|---|---|---|---|---|---|---|
| polyester | | | | | | | | | | | | | | | | val- | average |
| segment | | Part | mol | | Part | mol | | Part | mol | | Part | mol | | Part | mol | ue | molecular |
| a1 | Kind | (s) | % | Kind | (s) | % | Kind | (s) | % | Kind | (s) | % | Kind | (s) | % | SPₐ₁ | weight |
| 1 | BPA- | 45.5 | 34.1 | BPA- | 27.7 | 22.7 | TPA | 26.5 | 42.6 | — | — | — | FMA | 0.2 | 0.5 | 22.1 | 1,635.4 |
| | PO | | | EO | | | | | | | | | | | | | |
| 2 | BPA- | 45.6 | 34.3 | BPA- | 27.8 | 22.9 | TPA | 26.6 | 42.9 | — | — | — | — | — | — | 22.1 | 1,684.5 |
| | PO | | | EO | | | | | | | | | | | | | |
| 3 | BPA- | 73.9 | 56.9 | — | — | — | TPA | 25.9 | 42.6 | — | — | — | FMA | 0.2 | 0.5 | 21.9 | 1,684.5 |
| | PO | | | | | | | | | | | | | | | | |
| 4 | — | — | — | BPA- | 72.1 | 56.9 | TPA | 27.6 | 42.6 | — | — | — | FMA | 0.2 | 0.5 | 22.7 | 1,561.0 |
| | | | | EO | | | | | | | | | | | | | |
| 5 | BPA- | 21.3 | 14.9 | BPA- | 45.4 | 34.8 | TPA | 33.1 | 49.8 | — | — | — | FMA | 0.2 | 0.4 | 23.3 | 1,780.2 |
| | PO | | | EO | | | | | | | | | | | | | |
| 6 | BPA- | 60.5 | 45.5 | BPA- | 13.8 | 11.4 | TPA | 17.7 | 28.4 | APA | 7.8 | 14.2 | FMA | 0.2 | 0.5 | 21.5 | 1,702.9 |
| | PO | | | EO | | | | | | | | | | | | | |
| 7 | BPA- | 74.8 | 56.9 | — | — | — | TPA | 16.6 | 27.0 | APA | 8.4 | 15.6 | FMA | 0.2 | 0.5 | 21.3 | 1,730.6 |
| | PO | | | | | | | | | | | | | | | | |
| 8 | BPA- | 75.5 | 56.9 | — | — | — | TPA | 8.8 | 14.2 | APA | 15.5 | 28.4 | FMA | 0.2 | 0.5 | 21.1 | 1,727.0 |
| | PO | | | | | | | | | | | | | | | | |
| 9 | BPA- | 74.1 | 56.9 | — | — | — | TPA | 24.2 | 39.8 | APA | 1.5 | 2.8 | FMA | 0.2 | 0.5 | 21.7 | 1,734.2 |
| | PO | | | | | | | | | | | | | | | | |

The abbreviations in Table 1 are as described below.
BPA-PO: propylene oxide adduct of bisphenol A (average number of moles added: 2.2 mol)
BPA-EO: ethylene oxide adduct of bisphenol A (average number of moles added: 2.2 mol)
TPA: terephthalic acid
APA: adipic acid
FMA: fumaric acid

### Production Example of Amorphous Polyester Segment a2-1

| | |
|---|---|
| Ethylenediol | 20.7 parts by mass (41.2 mol %) |
| Terephthalic acid | 79.3 parts by mass (58.8 mol %) |

The above-mentioned materials were weighed in a reaction vessel with a stirring device that had been sufficiently dried by heating. With respect to 100 parts by mass of the mixture, 0.5 part by mass of tin 2-ethylhexanoate (esterification catalyst) was added. While a nitrogen gas was introduced into the vessel to keep an inert atmosphere, the temperature was increased to 200° C. to polymerize a resin (amorphous polyester segment a2-1). The resultant amorphous polyester segment a2-1 had a weight-average molecular weight Mw of 194 and an SP value of 26.0 (J/cm³)^{0.5}

### Production Example of Amorphous Polyester Segment a2-2

An amorphous polyester segment a2-2 was obtained by performing a reaction in the same manner as in the production example of the amorphous polyester segment a2-1 except that the respective polymerizable monomers and the numbers of parts thereof were changed as shown in Table 2, and the reaction time was changed so as to achieve a molecular weight shown in Table 2.

TABLE 2

| | | | | | | | | Weight- |
|---|---|---|---|---|---|---|---|---|
| Amorphous | | | | | | | SP | average |
| polyester | | | | | | | val- | molec- |
| segment | | Part | mol | | Part | mol | ue | ular |
| a2 | Kind | (s) | % | Kind | (s) | % | SPₐ₂ | weight |
| 1 | EG | 20.7 | 41.2 | TPA | 79.3 | 58.8 | 26.0 | 194.9 |
| 2 | EG | 27.2 | 50.0 | TPA | 72.8 | 50.0 | 25.6 | 208.2 |

The abbreviations in Table 2 are as described below.
TPA: terephthalic acid
EG: ethylenediol (ethylene glycol)

### Production Example of Amorphous Polyester A1

| | |
|---|---|
| ·Amorphous polyester segment a1-1 | 89.1 parts by mass |
| (48.8 mol % as converted using its number-average | |
| molecular weight as its molecular weight) | |
| Amorphous polyester segment a2-1 | 10.6 parts by mass |
| (48.8 mol % as converted using its number-average | |
| molecular weight as its molecular weight) | |

The above-mentioned materials were loaded into a reaction vessel with a condenser, a stirring machine, a nitrogen-introducing tube, and a thermocouple. Then, with respect to 100 parts by mass of the total amount of the segments, 0.5 part by mass of tin 2-ethylhexanoate (esterification catalyst) was added as a catalyst. Next, the flask was purged with a nitrogen gas, and then the temperature therein was gradually increased while the materials were stirred. The materials were subjected to a reaction for 2.5 hours while being stirred at a temperature of 200° C. Further, the pressure in the reaction vessel was reduced to 8.3 kPa and maintained thereat for 1 hour. After that, the temperature was cooled to 180° C., and the pressure was returned to atmospheric pressure.

| | |
|---|---|
| Methyl methacrylate | 0.2 part by mass (2.4 mol %) |

Next, while the contents were stirred, the above-mentioned material was added under a nitrogen atmosphere. Then, a mixture of 0.5 part by mass of dicumyl peroxide serving as a polymerization initiator with respect to 100 parts by mass of the total amount of the segments was added dropwise at 160° C. over 2 hours. After the completion of the dropwise addition, the pressure in the reaction vessel was reduced to 8.3 kPa, the temperature was increased to 200° C., and a reaction was performed. It was recognized that the softening point of the reaction product reached a temperature of 105° C., and then the temperature was reduced to stop the reaction. Thus, an amorphous polyester A1 was obtained. The resultant amorphous polyester A1 had an SP value of 23.1 (J/cm³)^{0.5.}

### Production Examples of Amorphous Polyesters A2 to A9

In the production example of the amorphous polyester A1, the kind and number of parts added of the amorphous polyester segments, and the presence or absence of the use of the crosslinking agent were changed as shown in Table 3, and the reaction time was changed so as to achieve physical properties shown in Table 4. Amorphous polyesters A2 to A9 were obtained in the same manner as in the production example of the amorphous polyester A1 except the foregoing.

TABLE 3

| Amorphous | Amorphous polyester | | | Amorphous polyester | | | | | | |
|---|---|---|---|---|---|---|---|---|---|---|
| polyester | segment a1 | | | segment a2 | | | Crosslinking agent | | | SPa2 − |
| A | Kind | Part(s) | mol % | Kind | Part(s) | mol % | Kind | Part(s) | mol % | SPa1 |
| 1 | a1-1 | 89.1 | 48.8 | a2-1 | 10.6 | 48.8 | MMA | 0.2 | 2.4 | 3.9 |
| 2 | a1-2 | 89.6 | 50.0 | a2-1 | 10.4 | 50.0 | — | 0 | 0 | 3.9 |
| 3 | a1-3 | 89.4 | 48.8 | a2-1 | 10.3 | 48.8 | MMA | 0.2 | 2.4 | 4.1 |
| 4 | a1-4 | 88.7 | 48.8 | a2-1 | 11.1 | 48.8 | MMA | 0.2 | 2.4 | 3.3 |
| 5 | a1-5 | 89.9 | 48.8 | a2-1 | 9.8 | 48.8 | MMA | 0.2 | 2.4 | 2.7 |
| 6 | a1-6 | 89.5 | 48.8 | a2-1 | 10.2 | 48.8 | MMA | 0.2 | 2.4 | 4.5 |
| 7 | a1-7 | 80.4 | 32.8 | a2-2 | 19.4 | 65.6 | MMA | 0.2 | 1.6 | 4.3 |
| 8 | a1-8 | 80.4 | 32.8 | a2-2 | 19.4 | 65.6 | MMA | 0.2 | 1.6 | 4.5 |
| 9 | a1-9 | 80.5 | 32.8 | a2-2 | 19.3 | 65.6 | MMA | 0.2 | 1.6 | 3.9 |

The abbreviation in Table 3 is as described below.
MMA: methyl methacrylate

### Production Example of Amorphous Polyester A10

| | |
|---|---|
| Polyoxypropylene(2.2)-2,2-bis(4- | 73.2 parts by mass (56.0 mol %) |
| hydroxyphenyl)propane: | |
| Terephthalic acid: | 26.6 parts by mass (43.7 mol %) |
| Trimellitic anhydride: | 0.2 part by mass (0.3 mol %) |
| Titanium tetrabutoxide (esterification | 0.5 part by mass |
| catalyst): | |

The above-mentioned materials were weighed in a reaction vessel with a condenser, a stirring machine, a nitrogen-introducing tube, and a thermocouple. Next, the flask was purged with a nitrogen gas, and then the temperature therein was gradually increased while the materials were stirred. The materials were subjected to a reaction for 5 hours while being stirred at 200° C. After that, it was recognized that the softening point of the reaction product reached a temperature of 96° C., and then the temperature was reduced to stop the reaction. Thus, an amorphous polyester A10 was obtained. Its physical properties are shown in Table 4.

TABLE 4

| | SP value | Softening point T_{A} |
|---|---|---|
| Amorphous polyester A | SP_{A} | (° C.) |
| 1 | 23.1 | 105 |
| 2 | 22.9 | 96 |
| 3 | 22.9 | 96 |
| 4 | 23.5 | 105 |
| 5 | 23.7 | 105 |
| 6 | 22.5 | 106 |
| 7 | 22.1 | 103 |
| 8 | 21.9 | 103 |
| 9 | 22.5 | 96 |
| 10 | 22.9 | 96 |

### Production Example of Crystalline Polyester C1

| | |
|---|---|
| Ethylene glycol: | 18.2 parts by mass (48.8 mol %) |
| Tetradecanedioic acid: | 71.9 parts by mass (46.3 mol %) |
| Behenic acid: | 10.0 parts by mass (4.9 mol %) |
| Tin 2-ethylhexanoate (esterification | 0.5 part by mass |
| catalyst): | |

The above-mentioned materials were weighed in a reaction vessel with a condenser, a stirring machine, a nitrogen-introducing tube, and a thermocouple. Next, the flask was purged with a nitrogen gas, and then the temperature therein was gradually increased while the materials were stirred. The materials were subjected to a reaction for 2 hours while being stirred at a temperature of 200° C.

Further, the materials were subjected to a reaction for 5 hours while the pressure in the reaction vessel was reduced to 8.3 kPa and the temperature therein was maintained at 200° C. After that, the temperature was reduced to stop the reaction. Thus, a crystalline polyester C1 was obtained.

### Production Examples of Crystalline Polyesters C2 to C16

In the production example of the crystalline polyester C1, the respective polymerizable monomers and the numbers of parts thereof were changed as shown in Table 5. In addition, the reaction time was changed so as to achieve physical properties shown in Table 6. Crystalline polyesters C2 to C16 were obtained in the same manner as in the production example of the crystalline polyester C1 except the foregoing. The physical properties of the crystalline polyesters C1 to C16 are shown in Table 6.

TABLE 5

| Crystalline | Linear aliphatic polyhydric | | | Linear aliphatic polyvalent | | | Aliphatic monocarboxylic acid | | |
|---|---|---|---|---|---|---|---|---|---|
| polyester | alcohol c1 | | | carboxylic acid c2 | | | or aliphatic monoalcohol | | |
| C | Kind | Part(s) | mol % | Kind | Part(s) | mol % | Kind | Part(s) | mol % |
| 1 | ED | 18.2 | 48.8 | TDA | 71.9 | 46.3 | BA | 10.0 | 4.9 |
| 2 | HD | 25.9 | 48.4 | ODA | 64.2 | 45.2 | BA | 9.9 | 6.5 |
| 3 | ED | 18.1 | 47.4 | DDA | 59.8 | 42.1 | BA | 22.1 | 10.5 |
| 4 | ED | 19.0 | 48.1 | DDA | 65.0 | 44.4 | BA | 16.0 | 7.4 |
| 5 | ED | 18.8 | 49.5 | TDA | 76.6 | 48.4 | BA | 4.6 | 2.2 |
| 6 | ED | 18.9 | 49.5 | TDA | 77.0 | 48.5 | BA | 4.1 | 2.0 |
| 7 | BD | 21.4 | 48.8 | ODA | 71.0 | 46.5 | BA | 7.7 | 4.7 |
| 8 | BD | 20.8 | 48.1 | ODA | 67.1 | 44.4 | BA | 12.1 | 7.4 |
| 9 | ED | 18.5 | 49.3 | TDA | 73.3 | 46.8 | BA | 8.1 | 3.9 |
| 10 | ED | 18.6 | 49.3 | TDA | 73.4 | 46.8 | BA | 8.0 | 3.9 |
| 11 | PD | 29.2 | 48.1 | UDA | 56.0 | 44.4 | BA | 14.7 | 7.4 |
| 12 | HD | 31.9 | 48.1 | UDA | 53.9 | 44.4 | BA | 14.2 | 7.4 |
| 13 | HD | 32.8 | 48.9 | DDA | 59.0 | 45.1 | PA | 8.3 | 6.0 |
| 14 | OD | 36.4 | 50.2 | TDA | 61.3 | 47.8 | PA | 2.3 | 1.9 |
| 15 | HD | 33.9 | 50.3 | DDA | 62.6 | 47.6 | OA | 3.4 | 2.1 |
| 16 | HD | 35.5 | 51.8 | DDA | 63.8 | 47.8 | OA | 0.7 | 0.4 |

The abbreviations in Table 5 are as described below.
ED: ethanediol (ethylene glycol) (number of carbon atoms: 2)
BD: butanediol (number of carbon atoms: 4)
PD: pentanediol (number of carbon atoms: 5)
HD: hexanediol (number of carbon atoms: 6)
OD: octanediol (number of carbon atoms: 8)
UDA: undecanedioic acid (number of carbon atoms: 11)
DDA: dodecanedioic acid (number of carbon atoms: 12)
TDA: tetradecanedioic acid (number of carbon atoms: 14)
ODA: octadecanedioic acid (number of carbon atoms: 18)
PA: pentadecanoic acid (number of carbon atoms: 15)
OA: octanoic acid (number of carbon atoms: 18)
BA: behenic acid (number of carbon atoms: 22)

TABLE 6

| | Difference in | Ratio of terminally | Melting | |
|---|---|---|---|---|
| | carbon number | modified structure among | point | SP |
| Crystalline | between c1 and | main chain terminals | Tc | value |
| polyester C | c2 | (%) | (° C.) | SPc |
| 1 | 12 | 98 | 90.0 | 19.8 |
| 2 | 12 | 98 | 82.0 | 19.0 |
| 3 | 10 | 98 | 86.0 | 19.6 |
| 4 | 10 | 98 | 87.0 | 19.8 |
| 5 | 12 | 98 | 92.0 | 20.0 |
| 6 | 12 | 98 | 93.0 | 20.0 |
| 7 | 14 | 98 | 85.0 | 19.2 |
| 8 | 14 | 98 | 84.0 | 19.2 |
| 9 | 12 | 80 | 90.0 | 19.8 |
| 10 | 12 | 79 | 90.0 | 19.8 |
| 11 | 6 | 98 | 90.0 | 19.6 |
| 12 | 5 | 98 | 90.0 | 19.8 |
| 13 | 6 | 80 | 90.0 | 19.6 |
| 14 | 6 | 40 | 90.0 | 19.4 |
| 15 | 6 | 20 | 90.0 | 19.6 |
| 16 | 6 | 5 | 68.0 | 19.8 |

### Production Example of Wax Dispersant

Low-molecular-weight polypropylene (VISCOL 660P manufactured by Sanyo Chemical Industries, Ltd.): 10.0 parts by mass (2.4 mol % with respect to the total number of moles of constituent monomers as converted using its number-average molecular weight as its molecular weight)
Xylene: 25.0 parts by mass

The above-mentioned materials were weighed in a reaction vessel with a condenser, a stirring machine, a nitrogen-introducing tube, and a thermocouple. Next, the flask was purged with a nitrogen gas, and then the temperature therein was gradually increased to a temperature of 175° C. while the materials were stirred.
Styrene: 68.0 parts by mass (76.4 mol % with respect to the total number of moles of constituent monomers)
Cyclohexyl methacrylate: 5.0 parts by mass (3.5 mol % with respect to the total number of moles of constituent monomers)
Butyl acrylate: 12.0 parts by mass (11.0 mol % with respect to the total number of moles of constituent monomers)
Methacrylic acid: 5.0 parts by mass (6.8 mol % with respect to the total number of moles of constituent monomers)
Xylene: 10.0 parts by mass
Di-t-butyl peroxyhexahydroterephthalate: 0.5 part by mass

After that, the above-mentioned materials were added dropwise over 3 hours, and the mixture was further stirred for 30 minutes. Then, the solvent was evaporated to provide a wax dispersant having a structure obtained through a reaction between a vinyl-based resin component and a hydrocarbon compound. The resultant wax dispersant had a peak molecular weight Mp of 6,000 and a softening point of 125° C.

### Production Example of Toner 1

Amorphous polyester A1: 88 parts by mass
Crystalline polyester C1: 12 parts by mass
Fischer-Tropsch wax (peak temperature of maximum endothermic peak: 100° C.): 5 parts by mass
The above-mentioned wax dispersant: 5 parts by mass
Carbon black: 5 parts by mass

The above-mentioned materials were mixed with a Henschel mixer (model FM-75, manufactured by Mitsui Mining Co., Ltd.) at a number of rotations of 1,500 rpm for a time of rotation of 5 min, and thereafter, the mixture was kneaded with a twin-screw kneading machine set to a temperature of 130° C. (model PCM-30, manufactured by Ikegai Corp.). The kneaded product thus obtained was cooled and coarsely pulverized with a hammer mill to 1 mm or less to provide a coarsely pulverized product. The coarsely pulverized product thus obtained was finely pulverized with a mechanical pulverizer (T-250, manufactured by Turbo Kogyo Co., Ltd.). Further, the finely pulverized product was classified with Faculty (F-300, manufactured by Hosokawa Micron Corporation). The operating conditions were as follows: the number of rotations of a classification rotor was set to 11,000 rpm and the number of rotations of a dispersion rotor was set to 7,200 rpm.
Toner particles 1:100 parts by mass

| | |
|---|---|
| Silica fine particles A: fumed silica subjected to surface | 4 parts by mass |
| treatment with hexamethyldisilazane (number-based | |
| median diameter (D50): 120 nm) | |
| Small-particle-diameter inorganic fine particles: titanium | 1 part by mass |
| oxide fine particles subjected to surface treatment with | |
| isobutyltrimethoxysilane (number-based median diameter | |
| (D50): 10 nm) | |

The above-mentioned materials were mixed with a Henschel mixer (model FM-75, manufactured by Mitsui Miike Chemical Engineering Machinery, Co., Ltd.) at a number of rotations of 1,900 rpm for a time of rotation of 10 min to provide a toner 1 showing negative chargeability.

### Production Examples of Toner 2 to Toner 25

A toner 2 to a toner 25 were obtained by performing the same operations as in the production example of the toner 1 except that, in the production example of the toner 1, the kind and amount of the amorphous polyester A, and the kind and amount of the crystalline polyester C were changed as shown in Table 7. The resultant physical properties are shown in Table 8.

TABLE 7

| | Formulation | | | | | | | |
|---|---|---|---|---|---|---|---|---|
| | | | | | Crystalline | | | |
| | Amorphous polyester A | | | | polyester C | | | T_{A} − |
| | | Part | | Part | | Part | SP_{A} − | T_{M} |
| Toner | Kind | (s) | Kind | (s) | Kind | (s) | SP_{C} | [° C.] |
| 1 | A1 | 88 | — | — | C1 | 12 | 3.3 | 11 |
| 2 | A2 | 88 | — | — | C1 | 12 | 3.1 | 11 |
| 3 | A1 | 48 | A3 | 48 | C1 | 5 | 3.2 | 7 |
| 4 | A1 | 48 | A3 | 48 | C1 | 4 | 3.2 | 6 |
| 5 | A1 | 85 | — | — | C1 | 15 | 3.3 | 14 |
| 6 | A1 | 84 | — | — | C1 | 16 | 3.3 | 15 |
| 7 | A4 | 88 | — | — | C2 | 12 | 4.5 | 7 |
| 8 | A5 | 88 | — | — | C2 | 12 | 4.7 | 6 |
| 9 | A1 | 26 | A6 | 62 | C3 | 12 | 3.0 | 17 |
| 10 | A1 | 26 | A6 | 62 | C4 | 12 | 2.8 | 18 |
| 11 | A7 | 88 | — | — | C1 | 12 | 2.3 | 20 |
| 12 | A8 | 88 | — | — | C1 | 12 | 2.0 | 21 |
| 13 | A1 | 88 | — | — | C5 | 12 | 3.1 | 10 |
| 14 | A1 | 88 | — | — | C6 | 12 | 3.1 | 10 |
| 15 | A1 | 88 | — | — | C7 | 12 | 3.9 | 9 |
| 16 | A1 | 88 | — | — | C8 | 12 | 3.9 | 8 |
| 17 | A1 | 79 | A3 | 9 | C9 | 12 | 3.3 | 11 |
| 18 | A1 | 79 | A3 | 9 | C10 | 12 | 3.3 | 11 |
| 19 | A1 | 79 | A3 | 9 | C11 | 12 | 3.5 | 11 |
| 20 | A1 | 79 | A3 | 9 | C12 | 12 | 3.3 | 11 |
| 21 | A1 | 79 | A3 | 9 | C13 | 12 | 3.5 | 13 |
| 22 | A7 | 88 | — | — | C14 | 12 | 2.7 | 3 |
| 23 | A9 | 88 | — | — | C15 | 12 | 2.9 | 3 |
| 24 | A10 | 88 | — | — | C1 | 12 | 3.1 | 11 |
| 25 | A10 | 88 | — | — | C16 | 12 | 3.1 | 23 |

TABLE 8

| | Physical properties | | | | | | | |
|---|---|---|---|---|---|---|---|---|
| | Endothermic peak A | Exothermic peak B | | Exothermic peak C | | Endothermic peak D | | |
| | Peak top | Peak top | Exothermic | Peak top | Exothermic | Peak top | Endothermic | |
| | temperature | temperature | quantity | temperature | quantity | temperature | quantity | T2 − T1 |
| Toner | [° C.] | [° C.] | [J/g] | [° C.] | [J/g] | [° C.] | [J/g] | [° C.] |
| 1 | 85.0 | 57.0 | 1.4 | 75.0 | 1.7 | 84.2 | 4.7 | −0.8 |
| 2 | 85.0 | 57.0 | 1.1 | 75.0 | 2.0 | 84.3 | 4.7 | −0.7 |
| 3 | 85.0 | 57.0 | 0.6 | 75.0 | 1.6 | 84.3 | 3.1 | −0.7 |
| 4 | 85.0 | 57.0 | 0.5 | 75.0 | 1.5 | 84.3 | 2.8 | −0.7 |
| 5 | 85.0 | 57.0 | 1.3 | 75.0 | 2.2 | 84.3 | 6.0 | −0.7 |
| 6 | 84.9 | 57.0 | 1.4 | 75.0 | 2.3 | 84.2 | 6.1 | −0.7 |
| 7 | 82.0 | 53.0 | 4.5 | 71.0 | 1.7 | 81.3 | 7.9 | −0.7 |
| 8 | 82.2 | 53.0 | 4.7 | 71.0 | 1.7 | 81.5 | 8.1 | −0.7 |
| 9 | 83.5 | 55.0 | 0.8 | 73.0 | 1.8 | 82.8 | 3.3 | −0.7 |
| 10 | 83.8 | 55.0 | 0.7 | 73.0 | 1.8 | 83.1 | 3.2 | −0.7 |
| 11 | 85.0 | 57.0 | 1.1 | 75.0 | 1.7 | 84.3 | 3.0 | −0.7 |
| 12 | 84.7 | 57.0 | 1.0 | 75.0 | 1.7 | 84.0 | 2.9 | −0.7 |
| 13 | 84.8 | 54.0 | 1.2 | 72.0 | 1.6 | 84.1 | 4.3 | −0.7 |
| 14 | 86.0 | 54.0 | 1.1 | 72.0 | 1.6 | 85.3 | 4.2 | −0.7 |
| 15 | 83.0 | 58.0 | 1.2 | 78.0 | 1.6 | 82.3 | 4.2 | −0.7 |
| 16 | 82.8 | 59.0 | 1.1 | 79.0 | 1.6 | 82.1 | 4.1 | −0.7 |
| 17 | 85.1 | 57.0 | 0.7 | 75.0 | 2.0 | 84.3 | 4.2 | −0.8 |
| 18 | 84.8 | 57.0 | 0.6 | 75.0 | 1.6 | 84.1 | 4.1 | −0.7 |
| 19 | 85.0 | 57.0 | 0.7 | 75.0 | 2.0 | 84.1 | 4.1 | −0.9 |
| 20 | 84.8 | 57.0 | 0.6 | 75.0 | 1.6 | 83.9 | 4.0 | −0.9 |
| 21 | 85.4 | 57.0 | 0.6 | 75.0 | 1.6 | 84.3 | 4.0 | −1.1 |
| 22 | 85.0 | 57.0 | 1.1 | 75.0 | 1.4 | 84.3 | 6.8 | −0.7 |
| 23 | 84.6 | 57.0 | 1.1 | 75.0 | 0.0 | 83.9 | 6.8 | −0.7 |
| 24 | 77.0 | 51.0 | 0.4 | 69.0 | 3.3 | 76.3 | 3.5 | −0.7 |
| 25 | — | — | 0.0 | — | 0.0 | — | 0.0 | 0 |

### <Production of Magnetic Carrier 1>

### Production Example of Magnetic Core

Step 1 (Weighing/mixing Step):

| | | |
|---|---|---|
| Fe₂O₃ | 61.7 | mass % |
| MnCO₃ | 34.2 | mass % |
| Mg(OH)₂ | 3.0 | mass % |
| SrCO₃ | 1.1 | mass % |

Ferrite raw materials were weighed at the above-mentioned ratios.

After that, the raw materials were pulverized and mixed with a dry ball mill using zirconia (φ10 mm) balls for 2 hours.

### Step 2 (Pre-Calcining Step):

After the pulverization and mixing, the mixture was calcined in the atmosphere with a burner-type calcining furnace at 950° C. for 2 hours to produce a pre-calcined ferrite. The composition of the ferrite is as described below.

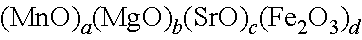

In the formula, a-0.40, b=0.07, c=0.01, and d=0.52.

### Step 3 (Pulverizing Step):

The pre-calcined ferrite was pulverized with a crusher into pieces each having a size of about 0.5 mm. After that, 30 parts by mass of water with respect to 100 parts by mass of the pre-calcined ferrite was added to the pieces, and then the mixture was pulverized with a wet ball mill using zirconia balls (φ1.0 mm) for 2 hours. After the balls had been separated, the remainder was pulverized with a wet bead mill using zirconia beads (φ1.0 mm) for 3 hours. Thus, a ferrite slurry was obtained.

### Step 4 (Granulating Step):

2.0 Parts by mass of polyvinyl alcohol with respect to 100 parts by mass of the pre-calcined ferrite was added as a binder to the ferrite slurry, and then the mixture was granulated into 40 μm spherical particles with a spray drier (manufacturer: Ohkawara Kakohki Co., Ltd.).

### Step 5 (Calcining Step):

The particles were calcined under a nitrogen atmosphere (oxygen concentration: 1.0 vol %) at 1,150° C. for 4 hours in an electric furnace for controlling a calcining atmosphere.

### Step 6 (Sorting Step):

After agglomerated particles had been shredded, coarse particles were removed by sieving with a sieve having an aperture of 250 μm. Thus, porous magnetic core particles were obtained.

### Step 7 (Resin Filling Step):

100.0 Parts by mass of the porous magnetic core particles were placed in the stirring container of a mixing and stirring machine (universal stirring machine model NDMV manufactured by Dalton Corporation). While the temperature was kept at 60° C. and the pressure was reduced to 2.3 kPa, nitrogen was introduced. A silicone resin solution was added dropwise at 7.5 parts by mass in terms of a resin component with respect to the porous magnetic core particles under reduced pressure, and stirring was continued for 2 hours after the completion of the dropwise addition. After that, the temperature was increased to 70° C., and the solvent was removed under reduced pressure to fill the particle interior of each of the porous magnetic core particles with a silicone resin composition obtained from the silicone resin solution. After cooling, the filled core particles thus obtained were transferred to a mixer having a spiral blade in a rotatable mixing container (drum mixer model UD-AT manufactured by Sugiyama Heavy Industrial Co., Ltd.), and the temperature was increased to 220° C. at a rate of temperature increase of 2° C./min under a nitrogen atmosphere and normal pressure. Heating and stirring were performed at this temperature for 60 minutes to cure the resin. After the heat treatment, a low-magnetic force product was separated by magnetic separation, and the remainder was classified with a sieve having an aperture of 150 μm to provide a magnetic core.

### Production Example of Coating Resin

80 Parts by mass of cyclohexyl methacrylate and 20 parts by mass of methyl methacrylate were added into a four-necked flask having a reflux condenser, a temperature gauge, a nitrogen inlet tube, and a grinding-type stirring device.

Further, 100 parts by mass of toluene, 100 parts by mass of methyl ethyl ketone, and 2.0 parts by mass of azobisisovaleronitrile were added. The resultant mixture was held under a stream of nitrogen at 70° C. for 10 hours. After the completion of the polymerization reaction, the resultant was repeatedly washed to provide a solution of a coating resin (solid content: 35 mass %).

### Production Example of Coating Liquid of Coating Resin

To the above-mentioned solution of the coating resin, toluene and methyl ethyl ketone were added at a ratio of 1:1 so as to achieve a resin solid content ratio of 5 mass %. The resultant mixture was stirred by shaking using a paint shaker (manufactured by RADIA) for 15 minutes to provide a coating liquid of the coating resin.

### Production Example of Magnetic Carrier 1

With use of the above-mentioned magnetic core, a planetary-screw mixer (Nauta mixer model VN manufactured by Hosokawa Micron Corporation) maintained at a temperature of 60° C. under reduced pressure (1.5 kPa) was loaded with the above-mentioned coating liquid of the coating resin at 3.0 parts by mass in terms of solid content with respect to 100 parts by mass of the magnetic core. The loading was performed in the following manner. A ⅓ amount of the resin coating liquid was loaded, followed by a solvent removal and coating operation for 20 minutes. Then, another ⅓ amount of the resin coating liquid was loaded, followed by a solvent removal and coating operation for 20 minutes, and still another ⅓ amount of the resin coating liquid was loaded, followed by a solvent removal and coating operation for 20 minutes.

After that, the resultant mixture was transferred to a mixer having a spiral blade in a rotatable mixing container (drum mixer model UD-AT manufactured by Sugiyama Heavy Industrial Co., Ltd.), and was subjected to heat treatment under a nitrogen atmosphere at a temperature of 120° C. for 2 hours while being stirred by rotating the mixing container at 10 rotations per minute. A low-magnetic force product was removed from the resultant mixture by magnetic separation, and the remainder was passed through a sieve having an aperture of 150 μm. After that, the resultant was classified with an air classifier. Thus, a magnetic carrier 1 was obtained.

### Production Example of Two-component Developer 1

92.0 Parts by mass of the magnetic carrier 1 and 8.0 parts by mass of the toner 1 were mixed with a V-type mixer (V-20 manufactured by Seishin Enterprise Co., Ltd.) to provide a two-component developer 1.

### Production Examples of Two-component Developers 2 to 24

Two-component developers 2 to 24 were each obtained by performing the same operation as in the production example of the two-component developer 1 except that the toner was changed as shown in Table 9.

TABLE 9

| | Two-component developer | Magnetic carrier | Toner |
|---|---|---|---|
| Example 1 | 1 | 1 | 1 |
| Example 2 | 2 | 1 | 2 |
| Example 3 | 3 | 1 | 3 |
| Example 4 | 4 | 1 | 4 |
| Example 5 | 5 | 1 | 5 |
| Example 6 | 6 | 1 | 6 |
| Example 7 | 7 | 1 | 7 |
| Example 8 | 8 | 1 | 8 |
| Example 9 | 9 | 1 | 9 |
| Example 10 | 10 | 1 | 10 |
| Example 11 | 11 | 1 | 11 |
| Example 12 | 12 | 1 | 12 |
| Example 13 | 13 | 1 | 13 |
| Example 14 | 14 | 1 | 14 |
| Example 15 | 15 | 1 | 15 |
| Example 16 | 16 | 1 | 16 |
| Example 17 | 17 | 1 | 17 |
| Example 18 | 18 | 1 | 18 |
| Example 19 | 19 | 1 | 19 |
| Example 20 | 20 | 1 | 20 |
| Comparative | 21 | 1 | 21 |
| Example 1 | | | |
| Comparative | 22 | 1 | 22 |
| Example 2 | | | |
| Comparative | 23 | 1 | 23 |
| Example 3 | | | |
| Comparative | 24 | 1 | 24 |
| Example 4 | | | |
| Comparative | 25 | 1 | 25 |
| Example 5 | | | |

### Example 1

### [Evaluations]

Evaluations were performed using the two-component developer 1.

A reconstructed machine of a printer for digital commercial printing “imageRUNNER ADVANCE C5560” manufactured by Canon Inc. was used as an image-forming apparatus, and the two-component developer 1 was loaded into its developing unit for Bk. As the reconstructed points of the apparatus, changes were made so that its fixation temperature and process speed, the DC voltage V_{DC} of a developer-carrying member, the charging voltage V_{D} of an electrostatic latent image-bearing member, and laser power were able to be freely set. Image output evaluation was performed as follows: an FFh image (solid image) having a desired image print percentage was output and subjected to evaluations to be described later with the V_{DC}, the V_{D}, and the laser power being adjusted so as to achieve a desired toner laid-on level on the FFh image on paper.

FFh is a value obtained by representing 256 gradations in hexadecimal notation; 00 h represents the first gradation (white portion) of the 256 gradations, and FFh represents the 256th gradation (solid portion) of the 256 gradations.

The evaluations were performed based on the following evaluation methods, and the results are shown in Table 10.

### [Low-Temperature Fixability]

Paper: High-whiteness paper [GFC-081 (81.0 g/m²) (sold from Canon Marketing Japan Inc.)]
Toner laid-on level on paper: 0.50 mg/cm² (adjusted based on the DC voltage V_{DC} of the developer-carrying member, the charging voltage V_{D} of the electrostatic latent image-bearing member, and the laser power)
Evaluation image: An image measuring 2 cm×5 cm was arranged at the center of the above-mentioned A4 paper.
Test environment: Low-temperature and low-humidity environment (L/L environment): temperature of 15° C./humidity of 10% RH
Fixation temperature: 150° C.
Process speed: 377 mm/sec

The evaluation image was output, and low-temperature fixability was evaluated. The value of an image density reduction ratio was used as an indicator for evaluating the low-temperature fixability.

For the image density reduction ratio, through use of an X-Rite color reflection densitometer (500 SERIES: manufactured by X-Rite, Inc.), the image density at the central portion of the image is measured first. Next, the fixed image is rubbed (back and forth 5 times) with lens-cleaning paper with the application of a load of 4.9 kPa (50 g/cm²) to the portion at which the image density has been measured, and the image density is measured again.

Then, the reduction ratio of the image density after the rubbing as compared to that before the rubbing was calculated using the following equation. The resultant image density reduction ratio was evaluated in accordance with the following evaluation criteria. A case of being evaluated as A to C was judged to have obtained the effect of the present invention.

$$Image density reduction ratio = ( image density before rubbing - image density after rubbing ) / image density before rubbing \times 100$$

### (Evaluation Criteria)

A: An image density reduction ratio of less than 3%
B: An image density reduction ratio of 3% or more and less than 5%
C: An image density reduction ratio of 5% or more and less than 7%
D: An image density reduction ratio of 7% or more

### [Charging Maintenance Ratio Under High-Temperature and High-Humidity Environment]

Paper: High-whiteness paper [GFC-081 (81.0 g/m²) (Canon Marketing Japan Inc.)] (sold from Canon Marketing Japan Inc.)
Toner laid-on level on paper: 0.35 mg/cm²
(adjusted based on the DC voltage V_{DC} of the developer-carrying member, the charging voltage V_{D} of the electrostatic latent image-bearing member, and the laser power)
Evaluation image: An image measuring 2 cm×5 cm was arranged at the center of the above-mentioned A4 paper.
Fixation test environment: High-temperature and high-humidity environment (H/H environment): temperature of 30° C./humidity of 80% RH
Process speed: 377 mm/sec

A toner on the electrostatic latent image-bearing member was collected by suction using a metal cylindrical tube and a cylindrical filter, and thereby the triboelectrification quantity of the toner was calculated. Specifically, the triboelectrification quantity of the toner on the electrostatic latent image-bearing member was measured with a Faraday cage. The “Faraday cage” refers to a coaxial double cylinder, and its inner cylinder and outer cylinder are insulated from each other. When a charged body having a charge quantity Q is placed in the inner cylinder, a substantial equivalent of the presence of a metal cylinder having the charge quantity Q is created through electrostatic induction. The induced charge quantity was measured with an electrometer (Keithley 6517A manufactured by Keithley Instruments, Inc.), and the quotient (Q/M) obtained by dividing the charge quantity Q (mC) by the mass M (kg) of the toner in the inner cylinder was adopted as the triboelectrification quantity of the toner. Triboelectrification quantity (mC/kg) of toner-Q/M

First, the evaluation image was formed on the electrostatic latent image-bearing member, and before its transfer onto an intermediate transfer member, the rotation of the electrostatic latent image-bearing member was stopped, and the toner on the electrostatic latent image-bearing member was collected by suction with a metal cylindrical tube and a cylindrical filter, and measured for its [initial Q/M].

Subsequently, in the H/H environment, the evaluation machine including the developing unit was left to stand for 2 weeks, and then the same operation as that before the standing was performed to measure a charge quantity Q/M (mC/kg) per unit mass on the electrostatic latent image-bearing member after the standing. The initial Q/M per unit mass on the electrostatic latent image-bearing member described above was set to 100%, and the maintenance ratio of the Q/M per unit mass on the electrostatic latent image-bearing member after the standing ([Q/M after standing]/[initial Q/M]×100) was calculated and judged by the following criteria. A case of being evaluated as A to C was judged to be satisfactory.

### (Evaluation Criteria)

A: A maintenance ratio of 95% or more
B: A maintenance ratio of 90% or more and less than 95%
C: A maintenance ratio of 85% or more and less than 90%
D: A maintenance ratio of less than 85%

### [Scratch Resistance]

Paper: Coated paper [Image Coat Gloss 158 (158.0 g/m²) (sold from Canon Marketing Japan Inc.)]
Toner laid-on level on paper: 0.05 mg/cm² (2Fh image)
(adjusted based on the DC voltage Voc of the developer-carrying member, the charging voltage V_{D} of the electrostatic latent image-bearing member, and the laser power)
Evaluation image: An image measuring 3 m×15 cm was arranged at the center of the above-mentioned A4 paper.
Fixation test environment: Normal-temperature and normal-humidity environment (N/N environment) (temperature of 23° C./humidity of 50% RH)
Fixation temperature: 180° C.
Process speed: 377 mm/sec

The above-mentioned evaluation image was output, and its scratch resistance was evaluated. The value of a difference in reflectance was used as an indicator for evaluating the scratch resistance. First, the image portion of the evaluation image is rubbed (back and forth 10 times) with fresh evaluation paper with the application of a load of 0.5 kgf through use of a Gakushin-type rubbing fastness tester (AB-301: manufactured by Tester Sangyo Co,. Ltd.). After that, the reflectance of a portion rubbed with the fresh evaluation paper, and the reflectance of an unrubbed portion are measured using a reflectometer (REFLECTOMETER MODEL TC-6DS: manufactured by Tokyo Denshoku Co., Ltd.).

Then, a difference between the reflectances before and after the rubbing was calculated using the following equation. The resultant difference between the reflectances was evaluated in accordance with the following evaluation criteria. A case of being evaluated as A to C was judged to be satisfactory.

Difference in reflectance=reflectance before rubbing−reflectance after rubbing

### (Evaluation Criteria)

A: less than 1.0%
B: 1.0% or more and less than 2.0%
C: 2.0% or more and less than 4.0%
D: 4.0% or more

### Example 2 to Example 20, and Comparative Example 1 to Comparative Example 5

Evaluations were performed in the same manner as in Example 1 except that the two-component developers 2 to 25 were used in place of the two-component developer 1. The results of the evaluations are shown in Table 10.

TABLE 10

| | Low-temperature fixability [%] | | | | | | | | Scratch | |
|---|---|---|---|---|---|---|---|---|---|---|
| | | Image | Image | | Charging maintaining property | | | | resistance | |
| | | density | density | | | Q/M | Q/M | | | Difference |
| | | before | after | Reduction | | before | after | Maintenance | | in |
| | | scratching | scratching | ratio | | standing | standing | ratio | | reflectance |
| Example 1 | A | 1.35 | 1.32 | 2% | A | 36 | 36 | 100% | A | 0.0% |
| Example 2 | A | 1.35 | 1.32 | 2% | B | 36 | 33 | 92% | A | 0.5% |
| Example 3 | B | 1.35 | 1.31 | 3% | A | 36 | 36 | 100% | A | 0.5% |
| Example 4 | C | 1.35 | 1.27 | 6% | B | 36 | 33 | 92% | B | 1.3% |
| Example 5 | A | 1.35 | 1.32 | 2% | B | 36 | 33 | 92% | B | 1.8% |
| Example 6 | A | 1.35 | 1.32 | 2% | C | 36 | 32 | 89% | C | 2.5% |
| Example 7 | B | 1.35 | 1.31 | 3% | A | 36 | 36 | 100% | A | 0.0% |
| Example 8 | C | 1.35 | 1.28 | 5% | A | 36 | 36 | 100% | A | 0.0% |
| Example 9 | A | 1.35 | 1.32 | 2% | B | 36 | 33 | 92% | B | 1.8% |
| Example 10 | A | 1.35 | 1.32 | 2% | C | 36 | 32 | 89% | C | 2.5% |
| Example 11 | A | 1.35 | 1.32 | 2% | B | 36 | 33 | 92% | B | 1.8% |
| Example 12 | A | 1.35 | 1.32 | 2% | C | 36 | 32 | 89% | C | 2.5% |
| Example 13 | B | 1.35 | 1.31 | 3% | B | 36 | 33 | 92% | B | 1.8% |
| Example 14 | B | 1.35 | 1.31 | 3% | C | 36 | 32 | 89% | C | 2.5% |
| Example 15 | B | 1.35 | 1.31 | 3% | A | 36 | 36 | 100% | A | 0.0% |
| Example 16 | C | 1.35 | 1.28 | 5% | A | 36 | 36 | 100% | A | 0.0% |
| Example 17 | A | 1.35 | 1.32 | 2% | B | 36 | 33 | 92% | B | 1.8% |
| Example 18 | A | 1.35 | 1.32 | 2% | C | 36 | 32 | 89% | C | 2.5% |
| Example 19 | A | 1.35 | 1.32 | 2% | B | 36 | 33 | 92% | B | 1.8% |
| Example 20 | A | 1.35 | 1.32 | 2% | C | 36 | 32 | 89% | C | 2.5% |
| Comparative Example 1 | A | 1.35 | 1.32 | 2% | B | 36 | 33 | 92% | D | 4.0% |
| Comparative Example 2 | D | 1.35 | 1.25 | 7% | A | 36 | 36 | 100% | B | 1.8% |
| Comparative Example 3 | D | 1.35 | 1.22 | 10% | A | 36 | 36 | 100% | A | 0.0% |
| Comparative Example 4 | A | 1.35 | 1.32 | 2% | D | 36 | 30 | 83% | C | 2.5% |
| Comparative Example 5 | A | 1.35 | 1.32 | 2% | D | 36 | 29 | 81% | D | 4.0% |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-204136, filed Dec. 21, 2022, and Japanese Patent Application No. 2023-064683, filed Apr. 12, 2023, which are hereby incorporated by reference herein in their entirety.

What is claimed is:

1. A toner comprising a toner particle containing a binder resin,
wherein the binder resin contains an amorphous polyester and a crystalline polyester, and
wherein, when the toner is used as a sample in differential scanning calorimetry (DSC) involving:
[I] a first process of increasing a temperature from 20° C. to 180° C. at a rate of temperature increase of 10° C./min;
[II] a second process of decreasing the temperature from 180° C. to 20° C. at a rate of temperature decrease of 10° C./min subsequent to the first process; and
[III] a third process of increasing the temperature from 20° C. to 180° C. at a rate of temperature increase of 10° C./min subsequent to the second process,
(i) a first DSC curve obtained through the first process has an endothermic peak A derived from the crystalline polyester, and the endothermic peak A has a peak top temperature of 80° C. or more and 100° C. or less,
(ii) a second DSC curve obtained through the second process has an exothermic peak B derived from the crystalline polyester, the exothermic peak B has a peak top temperature of 40° C. or more and 80° C. or less, and the exothermic peak B has an exothermic quantity of 0.5 J/g or more,
(iii) a third DSC curve obtained through the third process has an exothermic peak C derived from the crystalline polyester and an endothermic peak D derived from the crystalline polyester, the exothermic peak C has a peak top temperature of 40° C. or more and 80° C. or less, the exothermic peak C has an exothermic quantity of 1.5 J/g or more, and the endothermic peak D has a peak top temperature of 80° C. or more and 100° C. or less, and
(iv) when a temperature of a maximum peak top of the endothermic peak A is represented by T1 (° C.), and a temperature of a maximum peak top of the endothermic peak D is represented by T2 (° C.), the T1 and the T2 satisfy the following expression (1).
$$- 1. \leq T 2 - T 1 \qquad ( 1 )$$

2. The toner according to claim 1, wherein the endothermic peak D has an endothermic quantity of 3.0 J/g or more.

3. The toner according to claim 1,
wherein the crystalline polyester has, as units forming a main chain thereof, a structure derived from a linear aliphatic polyhydric alcohol c1 having 2 or more and 6 or less carbon atoms, and a structure derived from a linear aliphatic polyvalent carboxylic acid c2, and
wherein a difference in carbon number between the linear aliphatic polyhydric alcohol c1 and the linear aliphatic polyvalent carboxylic acid c2 is 6 or more.

4. The toner according to claim 1,
wherein the crystalline polyester contains one of: a modified crystalline polyester having a structure in which a hydroxy group at a main chain terminal is terminally modified with an aliphatic monocarboxylic acid having 16 or more and 31 or less carbon atoms; or a modified crystalline polyester having a structure in which a carboxy group at a main chain terminal is terminally modified with an aliphatic monoalcohol having 15 or more and 30 or less carbon atoms, and
wherein a ratio of the terminally modified structure among main chain terminals of all molecules in the crystalline polyester is 80.0% or more.

5. The toner according to claim 1, wherein, when a melting point of the crystalline polyester is represented by T_{C}, the T_{C} satisfies the following expression (2).
$$85. \leq Tc \leq 93. \qquad ( 2 )$$

6. The toner according to claim 1, wherein, when an SP value [(J/cm³)^{0.5}] of the crystalline polyester is represented by SP_{C}, and an SP value [(J/cm³)^{0.5}] of the amorphous polyester is represented by SP_{A}, the SP_{A} and the SP_{C} satisfy the following expression (3).
$$2. \leq {SP}_{A} - {SP}_{C} \leq 4.5 \qquad ( 3 )$$

7. The toner according to claim 1, wherein, when a softening point of the amorphous polyester measured with a flow tester is represented by T_{A} (° C.), and a softening point of a molten mixture of the amorphous polyester and the crystalline polyester mixed at a mass ratio between the amorphous polyester and the crystalline polyester in the toner is represented by T_{M} (° C.), a difference (T_{A}−T_{M}) between the T_{A} and the T_{M} is 7° C. or more and 17° C. or less.

8. The toner according to claim 1, wherein the binder resin contains 5 mass % or more and 15 mass % or less of the crystalline polyester.
